(19) United States
(12) Patent Application Publication
(10) Pub. No.: US 2002/0010715 A1
(43) Pub. Date: Jan. 24, 2002

(54) System and method for browsing using a limited display device

(76) Inventors: Garry Chinn, San Mateo, CA (US); Benedict R. Dugan, Seattle, WA (US); Roger E. Hagen, San Francisco, CA (US); Michael R. Sexton, San Francisco, CA (US); Sven H. Khatri, Oakland, CA (US); Tim J. King, San Francisco, CA (US)

Correspondence Address: F. Jason Far-Hadian, SKJERVEN MORRILL MacPHERSON LLP, 25 Metro Drive, Suite 700, San Jose, CA, 95110-1349, US

(21) Appl. No.: 09/916,095

(22) Filed: Jul. 26, 2001

(51) Int. Cl. G06F 15/00

(52) U.S. Cl. 707/514; 707/907

(57) ABSTRACT

A method comprising: providing a navigation tree comprising a semantic, hierarchical structure, having one or more paths associated with content of a conventional markup language document and a grammar comprising vocabulary including one or more keywords; receiving a request to access the content; responsive to the request, traversing a path in the navigation tree, if the request includes at least one keyword of the vocabulary, is provided.

### FIELD OF THE INVENTION

The invention relates generally to data communications and, in particular, to a system and method for browsing using a limited display device.

### BACKGROUND

The advent of a worldwide communication network known as the Internet has provided us with relatively instant access to an abundance of information, such as daily news, stock quotes, and other content in electronic documents available in the public domain. This information is stored in electronic file systems that are connected to create what is known as the World Wide Web (WWW). The content stored in these file systems is provided in the form of web pages that are typically linked to create one or more web sites. A person can access and view the content of a web page using a conventional web browser program, such as Microsoft's Internet Explorer or Netscape's Communicator that runs on a computer system.

Web pages typically include electronic files or documents formatted in a programming language such as Hyper-Text Markup Language (HTML) or eXtensible Markup Language (XML). Although these languages are suitable for presenting information on a desktop computer, they are generally not well suited for devices such as cellular telephones or web enabled personal digital assistants (PDAs) with limited display capability. Furthermore, neither conventional web browsers nor conventional markup languages support or allow users to readily access typical web pages available on the Internet via voice commands or commands from limited display devices.

Efforts have been made to address such problems. For example, voice-enabling languages, such as, Voice Extensible Markup Language (VoiceXML) have been developed. Unlike the conventional markup languages (e.g., HTML and XML), VoiceXML enables the delivery of information via voice commands. However, any information which is desirably delivered with VoiceXML must be separately constructed in that language, apart from the conventional markup languages. Because most web sites on the Internet do not provide separate VoiceXML capability, much of the information on the Internet is still largely inaccessible via voice commands, or limited display devices.

Systems and corresponding methods for efficiently accessing content stored on communication networks using voice commands or limited display devices are desirable.

### SUMMARY

According to an embodiment of the invention, systems and corresponding methods are provided to allow a user to access web content stored on a web server in a communications network, by using voice commands or a web enabled limited display device. The system includes an interface for receiving requests for content from the user and a processor coupled to the interface for retrieving one or more conventional markup language documents stored on a web server. The processor converts the conventional markup language document into a navigation tree that provides a semantic, hierarchical structure that includes some or all of the content included in the web pages presented by the conventional markup language documents. The system prunes out or converts unsuitable information, such as high definition images, that cannot be practically displayed or communicated to the user on a limited display device or via voice.

A technical advantage of the invention includes browsing content available from a communication network (e.g., the Internet) using voice commands, for example, from any telephone, wireless personal digital assistant, or other device with limited display capability. This system and method for voice browsing navigates through the content and delivers the same, for example, in the form of generated speech. The system and method can voice-enable any content formatted in a conventional, Internet-accessible markup language (e.g., HTML and XML), thus offering an unparalleled experience for users.

In one embodiment, the system generates one or more navigation trees from the conventional markup language documents. A navigation tree organizes the content of a web page into an outline or hierarchical structure that takes into account the meaning of the content, and thus can be used for semantic retrieval of the content. A navigation tree supports voice-based browsing of web pages. For documents formatted in various conventional markup languages, respective default style sheet (e.g., xCSS) documents may be provided for use in generating the navigation trees. Each style sheet document may contain metadata, such as declarative statements and procedural statements.

For each conventional markup language document, the system may construct a document tree comprising a number of nodes. The rules or declarative statements contained in a suitable style sheet document are used to modify the document tree, for example, by adding or modifying attributes at each node of the document tree, deleting unnecessary nodes, or filtering other nodes. If procedural statements are present in the style sheet document, the system and method may apply these procedures directly to construct the navigation tree. If there are no such procedural statements, the system and method may apply a simple mapping procedure to convert the document tree into the navigation tree.

In certain embodiments of the system, the navigation tree includes one or more branches. Each branch includes one or more nodes. Each node includes or is associated with one or more keywords, phrases, commands, or other information. These keywords, phrases, or commands are associated with corresponding web pages of a web site based on the content included in the web site and established connections or links among the web pages. A user, using the system, can navigate through the web pages and access the content stored on the site by traversing the nodes in the navigation tree.

Using voice commands, in one embodiment, a user may direct the system to perform the following operations, for example: browse the content of a web page, jump to a specific web page, move forward or backward within web pages or websites, make a selection from the content of a web page, edit input fields in a web page, and confirm selections or inputs to a web page. Each operation is associated with a separate command, keyword, or phrase. Once the system recognizes such command, keyword, or phrase provided by a user then the operation is performed.

A command is recognized if it is included in the system's navigation grammar. The navigation grammar includes vocabulary and navigation rules corresponding to the contents of the vocabulary. In some embodiments, to improve recognition efficiency, the system is implemented to include more than one voice recognition mode. In some modes the grammar is expanded while in other modes the grammar is narrowed. Expanding the grammar's vocabulary allows for more commands to be recognized. The larger the vocabulary, however, the higher are the possibilities for failure in accurate recognition.

Thus, in some embodiments the grammar is narrowed to maximize recognition. For example, in one recognition mode the grammar's vocabulary includes basic navigation commands that allow a user to navigate from a node to the node's immediate children, siblings, or parents. In another recognition mode, in addition to the basic navigation commands, the vocabulary may be expanded to include terms that allow navigating to nodes other than children, siblings, or parents of a node. As such, in the latter mode, navigation is not limited only to the immediately neighboring nodes.

In accordance with one embodiment, a method of accessing content from a communication network comprises: providing a navigation tree comprising a semantic, hierarchical structure, having one or more paths associated with content of a conventional markup language document and a grammar comprising vocabulary including one or more keywords; receiving a request to access the content; responsive to the request, traversing a path in the navigation tree, if the request includes at least one keyword of the vocabulary.

In certain embodiments, if the keyword included in the request is not included in the navigation vocabulary, the vocabulary is searched to find a close match for the command. If a match is found and confirmed, then the system operates to satisfy the command. If a match is not found or not confirmed, then one or more other commands included in the vocabulary are provided for selection. If the commands provided are not confirmed, then the system rejects the user request.

In accordance with one or more embodiments, a method performed on a computer for browsing content available from a communication network comprises: receiving a document containing the content in a conventional markup language format and a style sheet for the document; generating a document tree from the document; generating a style tree from the style sheet, the style tree comprising a plurality of style sheet rules; converting the document tree into a navigation tree using the style sheet rules, navigation tree associated with a vocabulary having one or more keywords the navigation tree including one or more content nodes and routing nodes defining paths of the navigation tree, each content node including some portion of the content and a keyword associated with the respective portion of the content, each routing node including at least one keyword referencing other nodes in the navigation tree; receiving a request to access the content; and traversing a path in the navigation tree, adding any key words included in any node along the traversed path to the vocabulary in response to the request.

In one embodiment, speech recognition is used to recognize the command or keyword included in the request and a confidence score is assigned to the result of the speech recognition. If the confidence score is below a rejection threshold, the request is rejected. Alternatively, if the confidence score is greater than a recognition threshold, then the request is accepted. Where the confidence score is between the rejection threshold and the recognition threshold, the result is considered ambiguous. To resolve the ambiguity of the result, the system searches the grammar's vocabulary to find one or more close matches for the command or keyword and narrows the grammar to include said one or more close matches.

If any close matches are found, then the system provides said one or more close matches for selection. The system then queries the user to confirm whether or not the closest match recognized by the system is in fact the command meant to be conveyed by the user. If so, the command is recognized and performed. Otherwise, the system fails to recognize the command and provides the user with one or more help messages. The help messages are designed to narrow the grammar, guide the user, and allow him/her to repeat the request. The system counts the number of recognition failures and provides a variety of different help messages to assist the user. As a last resort, the system reverts back to a previous navigation step and allows the user to start over, for example.

The system is designed to dynamically build the navigation grammar based on keywords or other vocabulary included in the nodes of the navigation tree. Since the grammar is built dynamically, in certain embodiments, the grammar built at each navigation instance is specific to the navigation route selected by the user. In some navigation modes the system is designed to streamline and narrow the vocabulary included in the grammar to those keywords and commands that are relevant to the tree branch being traversed at the time. A smaller grammar maximizes recognition accuracy by reducing the possibilities of failure in recognition. As such, narrowing the grammar at each stage allows the system to detect and process user commands more accurately and efficiently.

In some embodiments, the system includes a default grammar. The default grammar includes the basic commands and rules that allow a user to perform basic navigable operations. Examples of basic navigable operations include moving forward or backward in navigation steps or returning to the home page of a web site. Help and assist features are included in one or more embodiments of the system to detect commands that are ambiguous or vague and to guide a user on how to properly navigate or command the system.

According to another embodiment of the invention, a computer system for allowing a user of a limited display device to browse content available from a communication network includes a gateway module. The gateway module is operable to receive a user request, and to recognize the request. A browser module, in communication with the gateway module, is operable to retrieve a conventional markup language document and a style sheet document from the communication network in response to the request.

The conventional markup language document contains content; the style sheet document contains metadata. The browser module is operable to generate a navigation tree using the conventional markup language document and the style sheet document. The navigation tree provides a semantic, hierarchical structure for the content. The gateway module and the browser module cooperate to enable the user to browse the content using the navigation tree and to generate output conveying the content to the user via the limited display device.

Other aspects and advantages of the invention will be more fully understood from the following descriptions and accompanying drawings.

BRIEF DESCRIPTION OF THE DRAWINGS

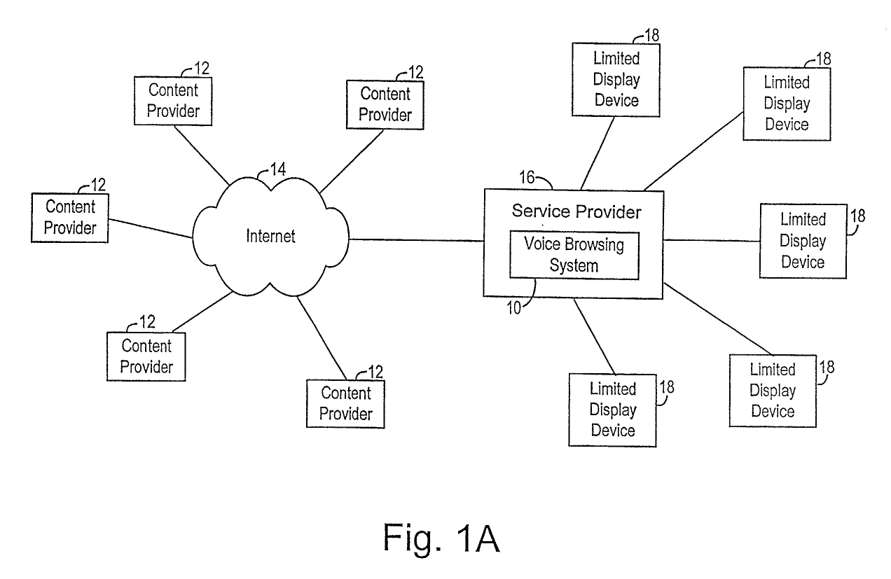

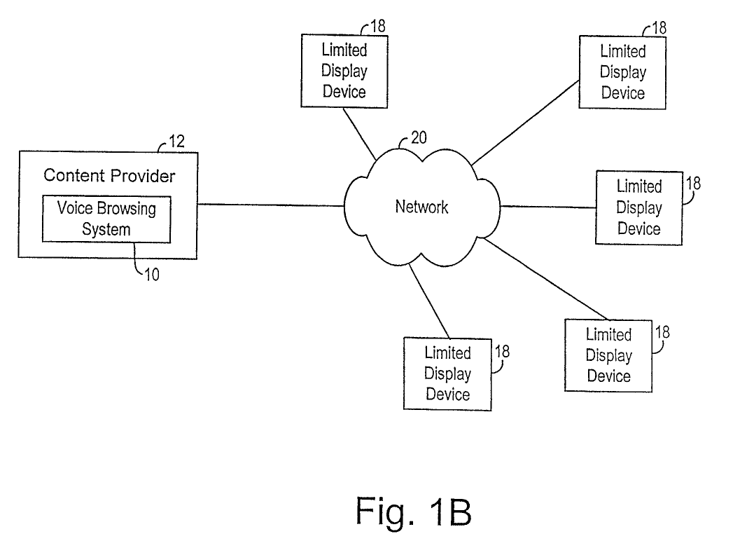

FIG. 1A illustrates an exemplary environment in which a voice browsing system, according to an embodiment of the invention, may operate.

FIG. 1B illustrates another exemplary environment in which a voice browsing system, according to an embodiment of the invention, may operate.

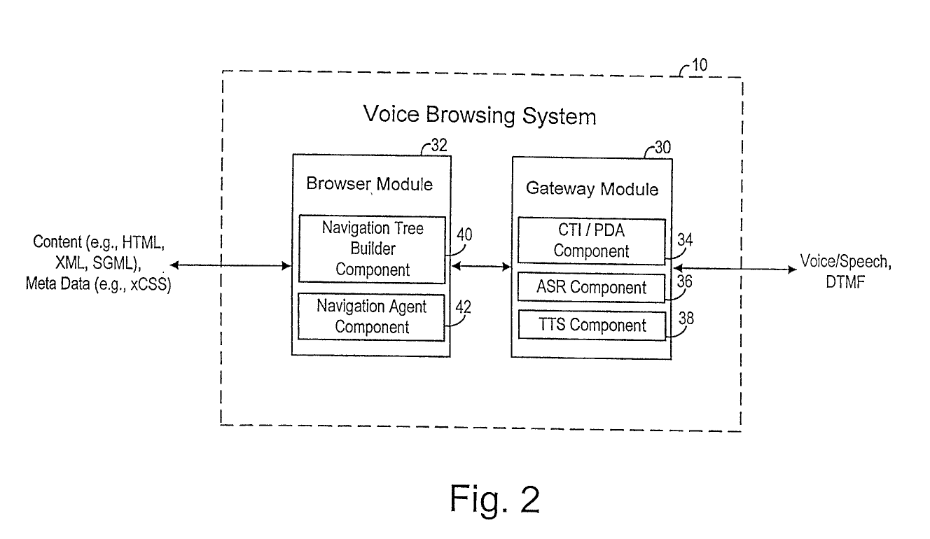

FIG. 2 is a block diagram of a voice browsing system, according to an embodiment of the invention.

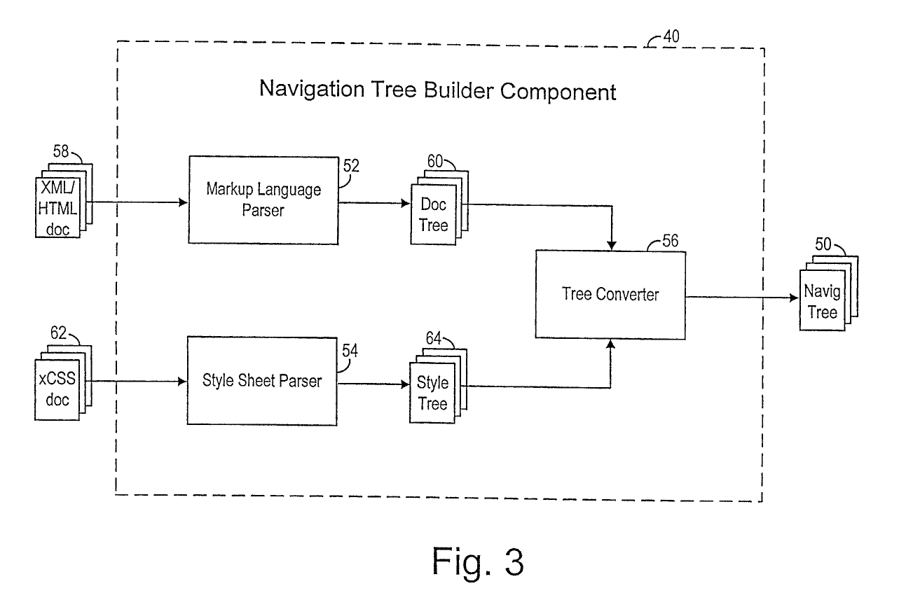

FIG. 3 is a block diagram of a navigation tree builder component, according to an embodiment of the invention.

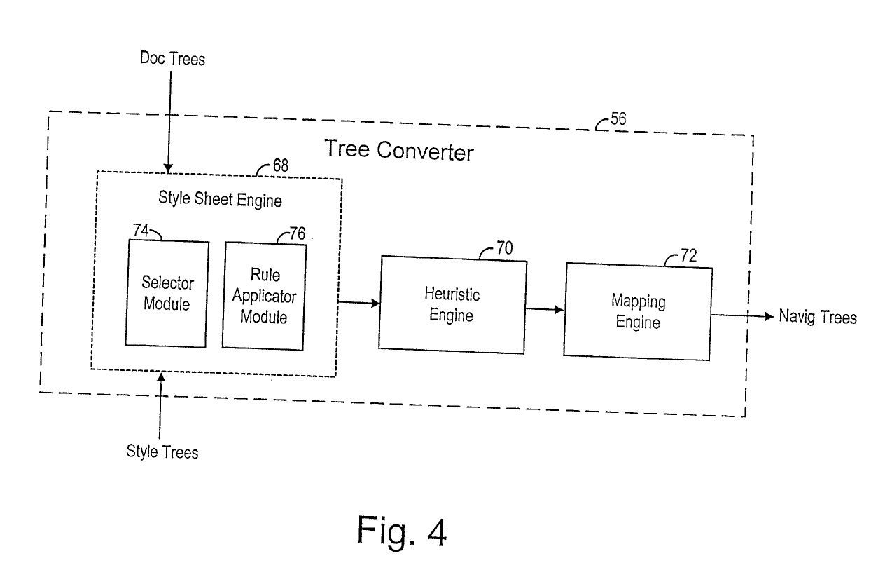

FIG. 4 is a block diagram of a tree converter, according to an embodiment of the invention.

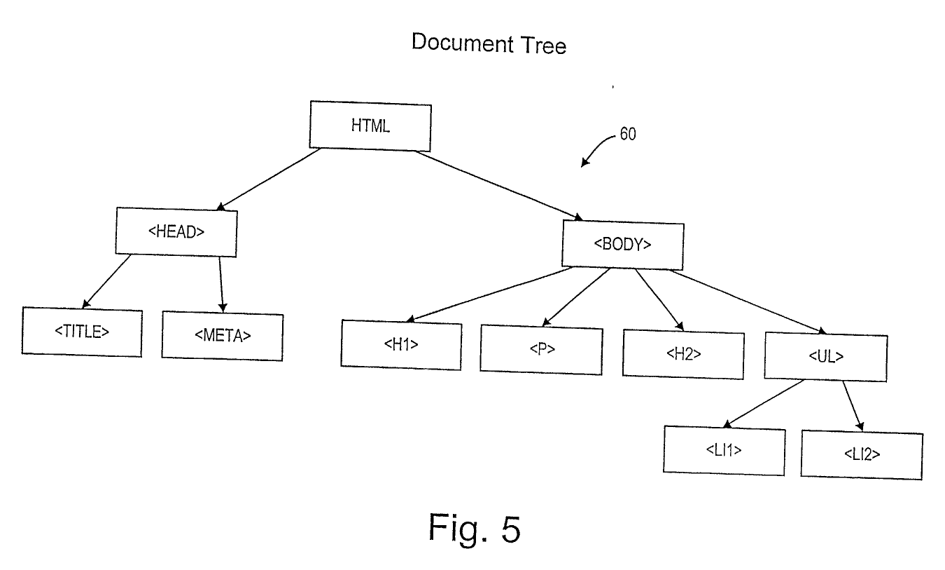

FIG. 5 illustrates an exemplary document tree, according to an embodiment of the invention.

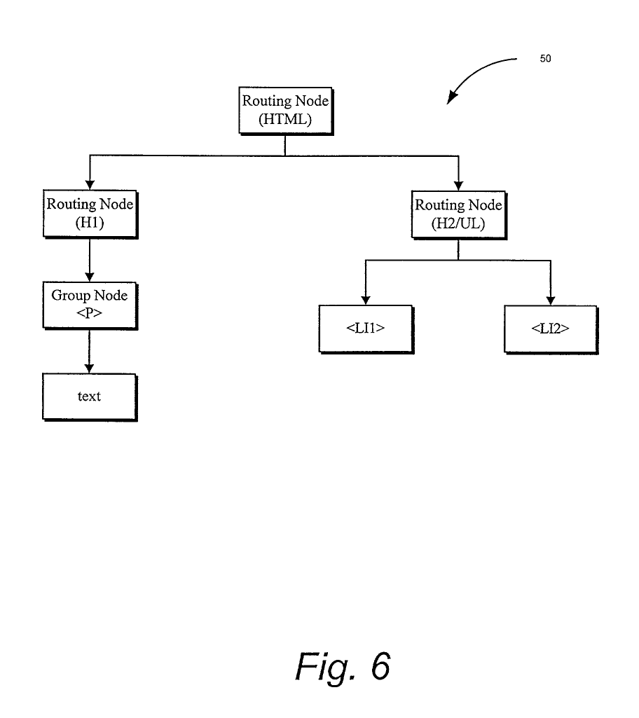

FIG. 6 illustrates an exemplary navigation tree, according to an embodiment of the invention.

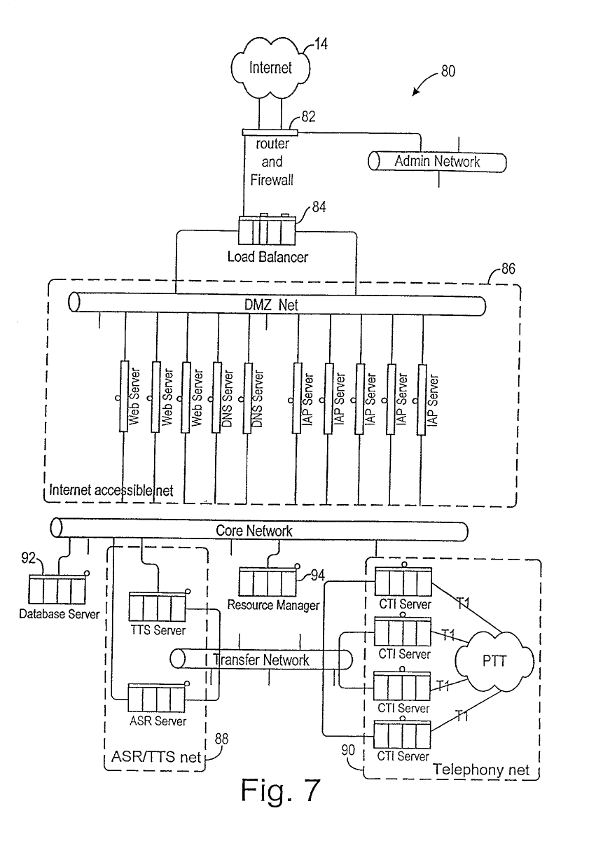

FIG. 7 illustrates a computer-based system which is an exemplary hardware implementation for the voice browsing system, according to an embodiment of the invention.

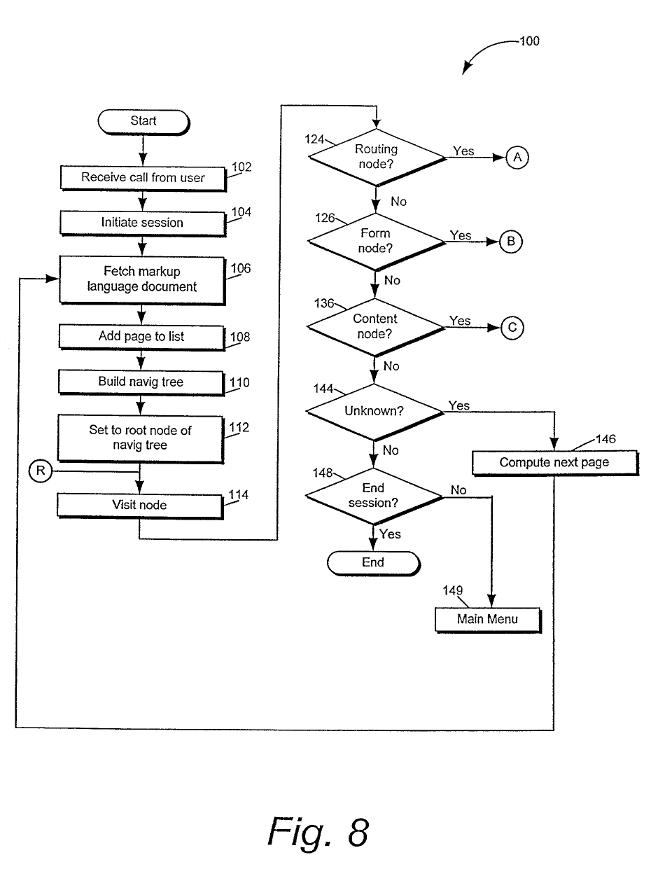

FIG. 8 is a flow diagram of an exemplary method for browsing content with voice commands, according to an embodiment of the invention.

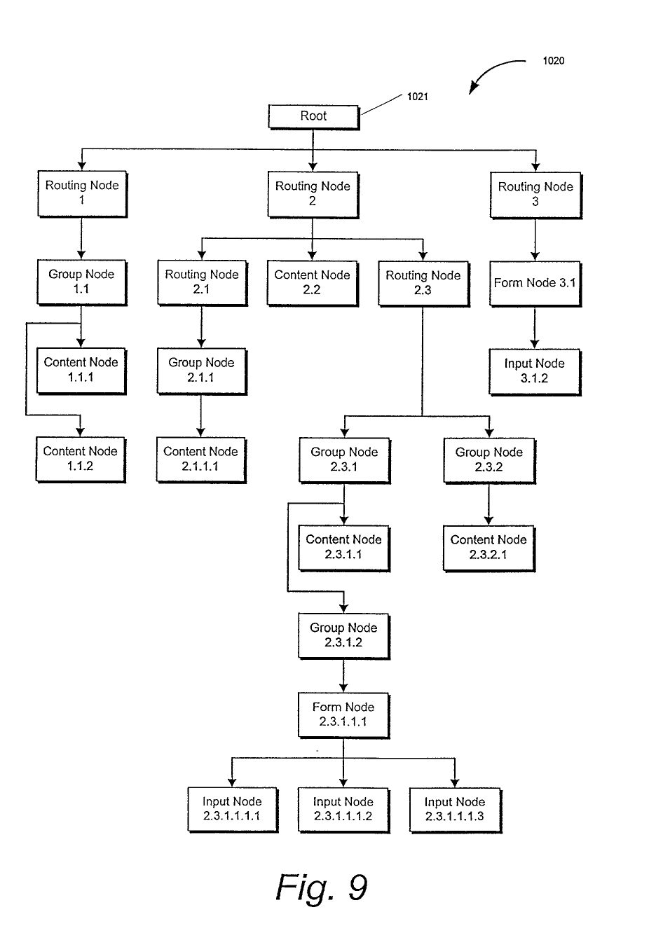

FIG. 9 is a block diagram of exemplary nodes in a navigation tree, according to an embodiment of the invention.

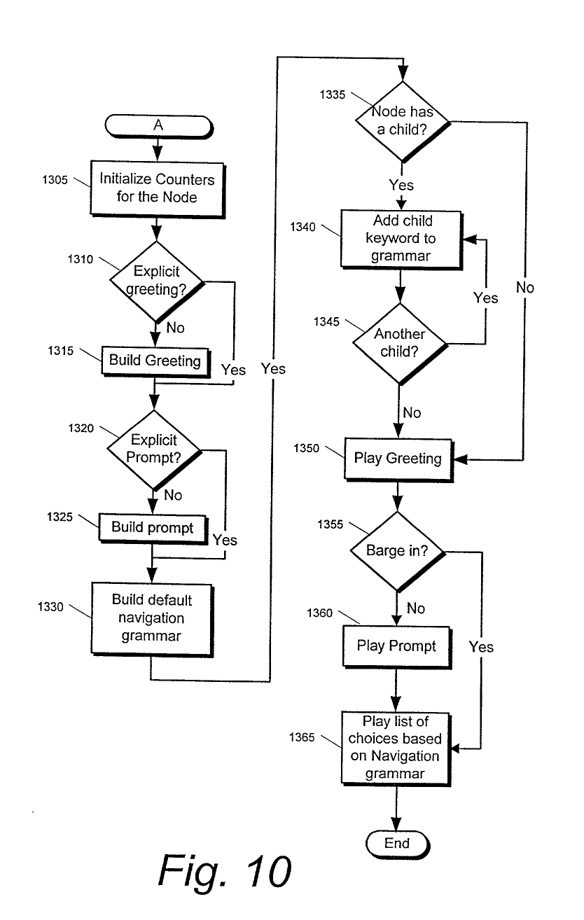

FIG. 10 is a flow diagram illustrating a method of navigating a routing node, according to an embodiment of the invention.

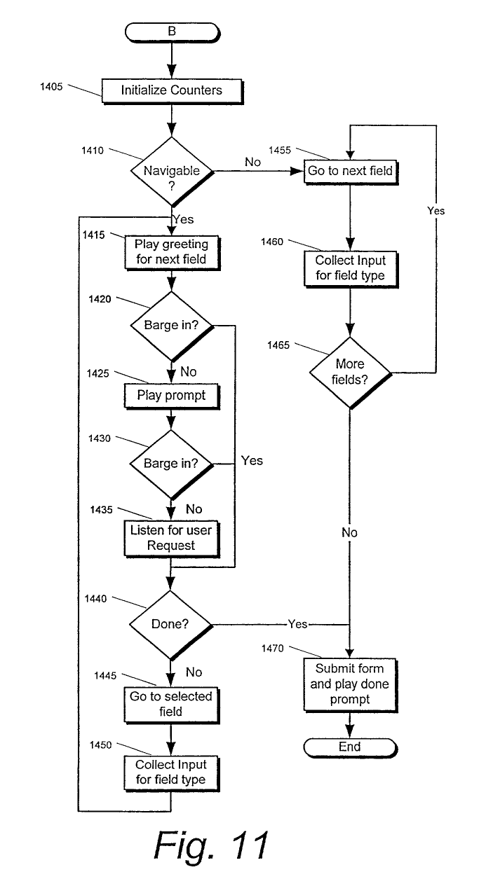

FIG. 11 is a flow diagram illustrating a method of navigating a form node, according to an embodiment of the invention.

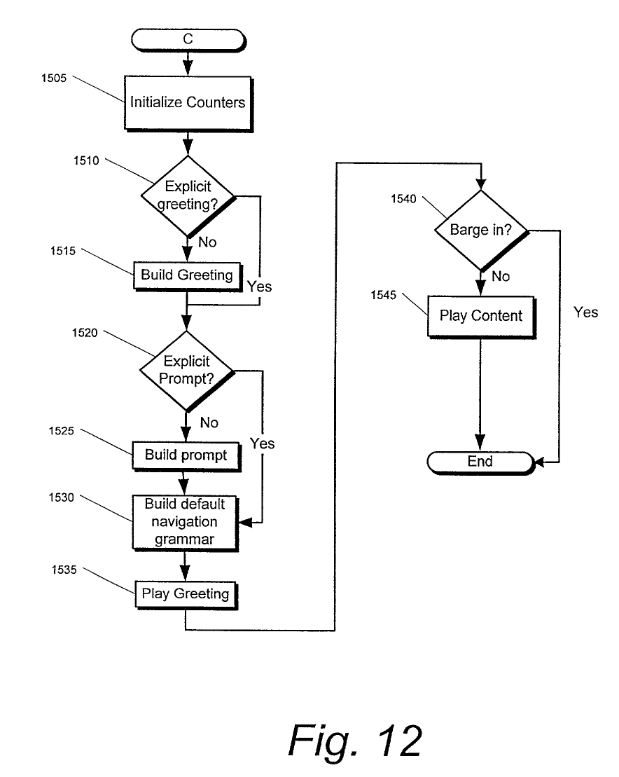

FIG. 12 is a flow diagram illustrating a method of navigating a content node, according to an embodiment of the invention.

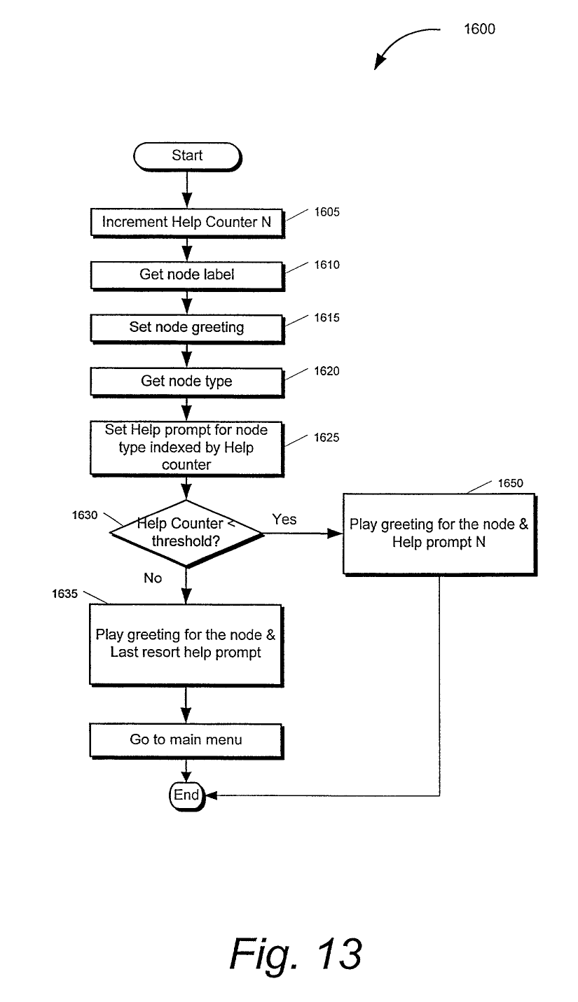

FIG. 13 is a flow diagram illustrating a method of providing a user with assistance, according to an embodiment of the invention.

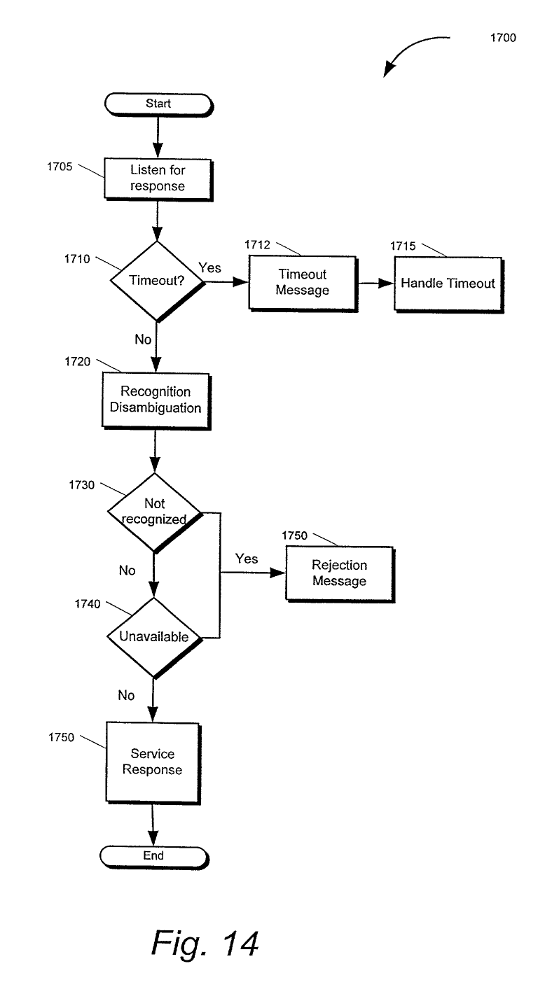

FIG. 14 is a flow diagram illustrating a method of processing a user request, according to an embodiment of the invention.

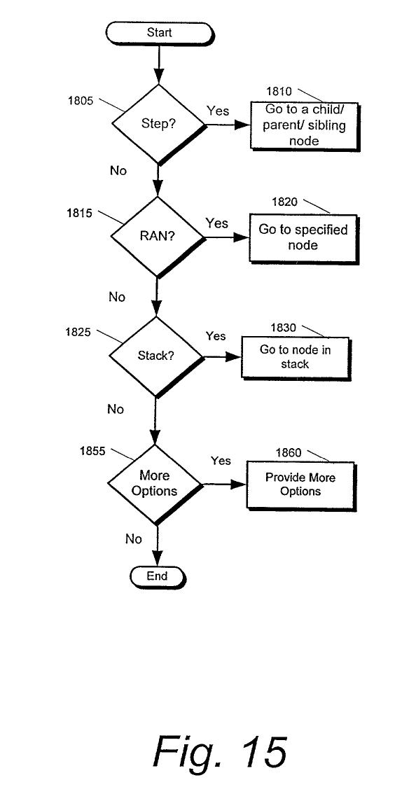

FIG. 15 is a flow diagram illustrating one or more navigation modes, according to an embodiment of the invention.

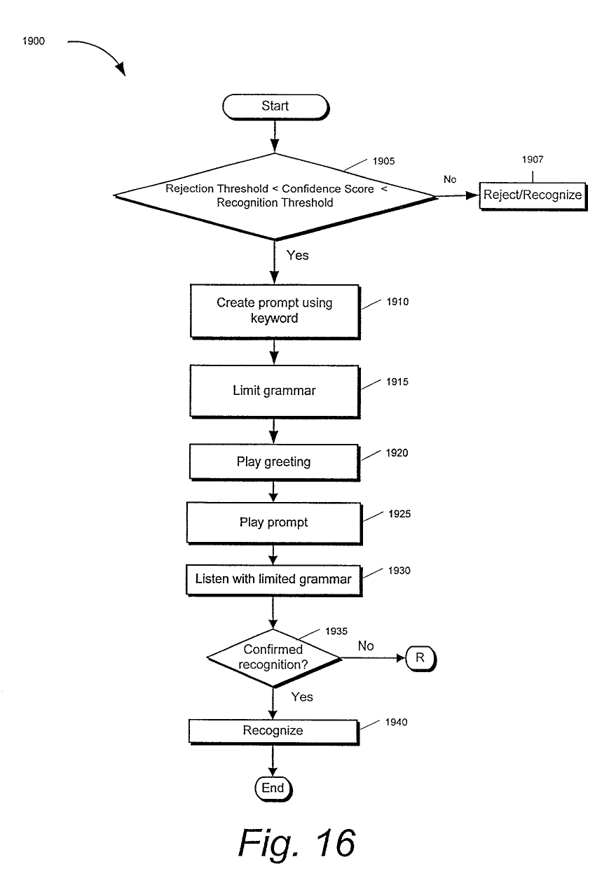

FIG. 16 is a flow diagram illustrating a method of voice recognition, according to an embodiment of the invention.

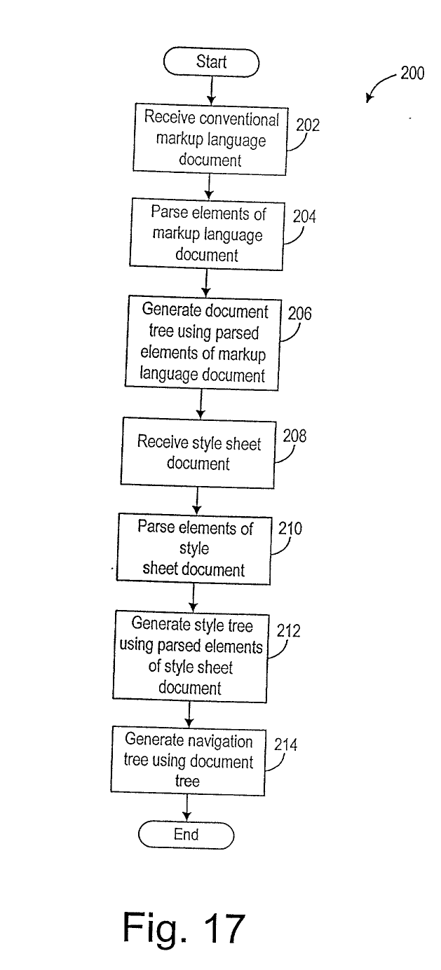

FIG. 17 is a flow diagram of an exemplary method for generating a navigation tree, according to an embodiment of the invention.

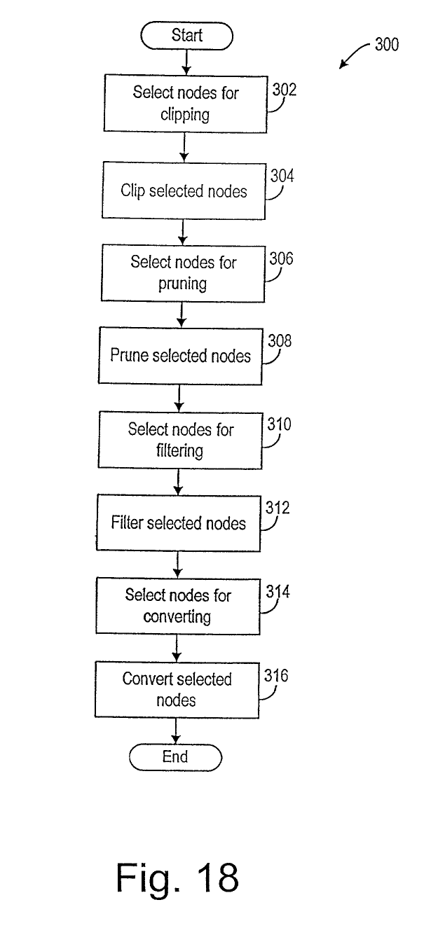

FIG. 18 is a flow diagram of an exemplary method for applying style sheet rules to a document tree, according to an embodiment of the invention.

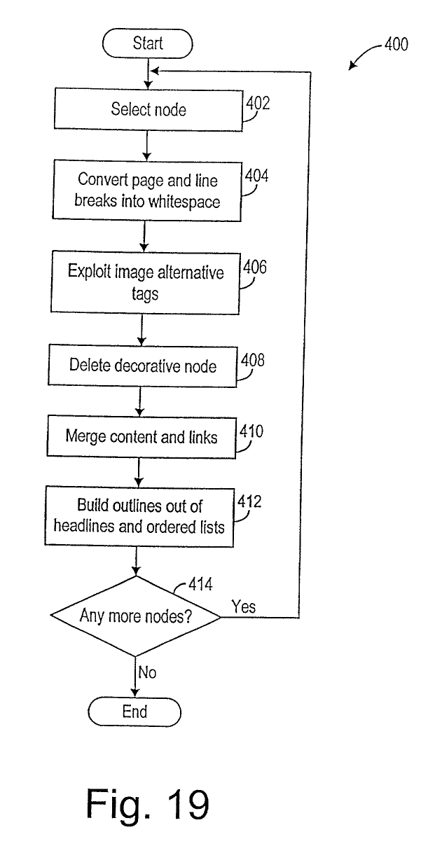

FIG. 19 is a flow diagram of an exemplary method for applying heuristic rules to a document tree, according to an embodiment of the invention.

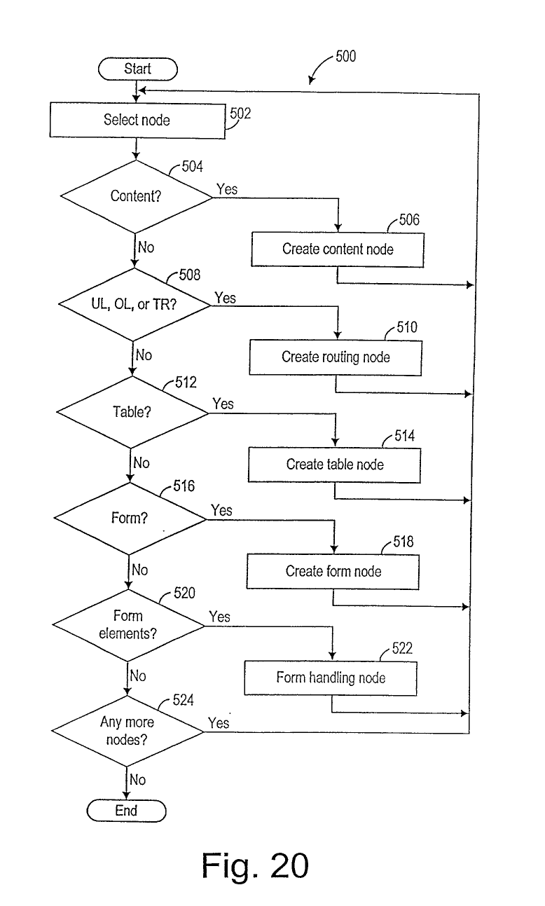

FIG. 20 is a flow diagram of an exemplary method for mapping a document tree into a navigation tree, according to an embodiment of the invention.

Features, elements, and aspects of the invention that are referenced by the same numerals in different figures represent the same, equivalent, or similar features, elements, or aspects in accordance with one or more embodiments of the system.

### DETAILED DESCRIPTION

The invention and its advantages, according to one or more embodiments, are best understood by referring to FIGS. 1-20 of the drawings. Like numerals are used for like and corresponding parts of the various drawings. The invention, its advantages, and various embodiments are described in detail below. Certain aspects of the invention are described in more detail in U.S. patent application Ser. No. 09/614,504 (Attorney Matter No. M-8247 US), filed Jul. 11, 2000, entitled “System And Method For Accessing Web Content Using Limited Display Devices,” with a claims of priority under 35 U.S.C. § 119(e) to Provisional Application No. 60/142,429, (Attorney Matter No. P-8247 US), filed Nov. 9, 1999, entitled “System And Method For Accessing Web Content Using Limited Display Devices.” The entire content of the above-referenced applications is incorporated by referenced herein.

Turning first to the nomenclature of the specification, the detailed description which follows is represented largely in terms of processes and symbolic representations of operations performed by conventional computer components, such as a local or remote central processing unit (CPU) or processor associated with a general purpose computer system, memory storage devices for the processor, and connected local or remote pixel-oriented display devices. These operations include the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For purposes of this discussion, a process, method, routine, or sub-routine is generally considered to be a sequence of computer-executed steps leading to a desired result. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, searching, or the like, which are often associated with manual operations performed by a human operator. It must be understood that no involvement of the human operator may be necessary, or even desirable, in the invention. The operations described herein are machine operations performed in conjunction with the human operator or user that interacts with the computer or computers.

In addition, it should be understood that the programs, processes, methods, and the like, described herein are but an exemplary implementation of the invention and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as read-only memory (ROM).

Exemplary Environment

FIG. 1A illustrates an exemplary environment in which a voice browsing system 10, according to an embodiment of the invention, may operate. In this environment, one or more content providers 12 may provide content to any number of interested users. Each content provider can be an entity which operates or maintains a portal or any other web site through which content can be delivered. Each portal or web site, which can be supported by a suitable computer system or web server, may include one or more web pages at which content is made available. Each web site or web page can be identified by a respective uniform resource locator (URL).

Content can be any data or information that is presentable (visually, audibly, or otherwise) to users. Thus, content can include written text, images, graphics, animation, video, music, voice, and the like, or any combination thereof. Content can be stored in digital form, such as, for example, a text file, an image file, an audio file, a video file, etc. This content can be included in one or more web pages of the respective portal or web site maintained by each content provider 12.

These web pages can be supported by documents formatted in a conventional, Internet-accessible markup language, such as, for example, Hyper-Text Markup Language (HTML) and eXtensible Markup Language (XML). HTML and XML are markup language standards set by the World Wide Web Consortium (W3C) for Internet-accessible documents. In general, conventional markup languages provide formatting and structure for content that is to be presented visually. That is, conventional markup languages describe the way that content should be displayed, for example, by specifying that text should appear in boldface, which location a particular image should appear, etc. In markup languages, tags are added or embedded within content to describe how the content should be formatted and displayed. A conventional, Internet-accessible markup language document can be the source page for any browser on a computer.

Along with the content, each content provider 12 may also maintain metadata that can be used to guide the construction of a semantic representation for the content. Metadata may include, for example, declarative statements (rules) and procedural statements. This metadata can be contained in one or more style sheet documents, which are essentially templates that apply formatting and style information to the elements of a web page. A style sheet document can be, for example, an extended Cascading Style Sheet (xCSS) document. In one embodiment, a separate default style sheet documents may be provided for each conventional markup language (e.g., HTML or XML). As an alternative to style sheets, metadata can be contained in documents formatted in a suitable descriptive language such as Resource Description Framework. Using style sheet documents (or other appropriate documents), auxiliary metadata can be applied to a web page supported by a conventional markup language document.

One or more communication networks, such as the Internet 14, can be used to deliver content. Internet 14 is an interconnection of computer clients and servers located throughout the world and exchanging information according to Transmission Control Protocol/Internet Protocol (TCP/IP), Internetwork Packet eXchange/Sequence Packet eXchange (IPX/SPX), AppleTalk, or other suitable protocol. Internet 14 supports the distributed application known as the “World Wide Web.” As described herein, web servers maintain web sites, each comprising one or more web pages at which information is made available for viewing.

Each web site or web page may be supported by documents formatted in any suitable conventional markup language (e.g., HTML or XML). Clients may locally execute a conventional web browser program. A conventional web browser is a computer program that allows exchange information with the World Wide Web. Any of a variety of conventional web browsers are available, such as NETSCAPE NAVIGATOR from Netscape Communications Corp., INTERNET EXPLORER from Microsoft Corporation, and others that allow convenient access and navigation of the Internet 14. Information may be communicated from a web server to a client using a suitable protocol, such as, for example, Hypertext Transfer Protocol (HTTP) or File Transfer Protocol (FTP).

A service provider 16 is connected to Internet 14. As used herein, the terms “connected,” “coupled,” or any variant thereof, mean any connection or coupling, either direct or indirect, between two or more elements; such connection or coupling can be physical or logical. Service provider 16 may operate a computer system that appears as a client on Internet 14 to retrieve content and other information from content providers 12.

In general, service provider 16 can be an entity that delivers services to one or more users. These services may include telephony and voice services, including plain old telephone service (POTS), digital services, cellular service, wireless service, pager service, etc. To support the delivery of services, service provider 16 may maintain a system for communicating over a suitable communication network, such as, for example, a telecommunications network. Such telecommunications network allows communication via a telecommunications line, such as an analog telephone line, a digital T1 line, a digital T3 line, or an OC3 telephony feed.

The telecommunications network may include a public switched telephone network (PSTN) and/or a private system (e.g., cellular system) implemented with a number of switches, wire lines, fiber-optic cable, land-based transmission towers, space-based satellite transponders, etc. In one embodiment, the telecommunications network may include any other suitable communication system, such as a specialized mobile radio (SMR) system. As such, the telecommunications network may support a variety of communications, including, but not limited to, local telephony, toll (i.e., long distance), and wireless (e.g., analog cellular system, digital cellular system, Personal Communication System (PCS), Cellular Digital Packet Data (CDPD), ARDIS, RAM Mobile Data, Metricom Ricochet, paging, and Enhanced Specialized Mobile Radio (ESMR)).

The telecommunications network may utilize various calling protocols (e.g., Inband, Integrated Services Digital Network (ISDN) and Signaling System No. 7 (SS7) call protocols) and other suitable protocols (e.g., Enhanced Throughput Cellular (ETC), Enhanced Cellular Control (EC²), MNP10, MNP10-EC, Throughput Accelerator (TXCEL), Mobile Data Link Protocol, etc.). Transmissions over the telecommunications network system may be analog or digital. Transmission may also include one or more infrared links (e.g., IRDA).

One or more limited display devices 18 may be coupled to the network maintained by service provider 16. Each limited display device 18 may comprise a communication device with limited capability for visual display. Thus, a limited display device 18 can be, for example, a wired telephone, a wireless telephone, a smart phone, a wireless personal digital assistant (PDA), and Internet televisions. Each limited display device 18 supports communication by a respective user, for example, in the form of speech, voice, or other audible information. Limited display devices 18 may also support dual tone multi-frequency (DTMF) signals.

Voice browsing system 10, as depicted in FIG. 1A, may be incorporated into a system maintained by service provider 16. Voice browsing system 10 is a computer-based system which generally functions to allow users with limited display devices 18 to browse content provided by one or more content providers 12 using, for example, spoken/voice commands or requests. In response to these commands or requests, voice browsing system 10, acting as a client, interacts with content providers 12 via Internet 14 to retrieve the desired content. Then, voice browsing system 10 delivers the desired content in the form of audible information to the limited display devices 18. To accomplish this, in one embodiment, voice browsing system 10 constructs or generates navigation trees using style sheet documents to supply metadata to conventional markup language (e.g., HTML or XML) documents.

Navigation trees are semantic representations of web pages that serve as interactive menu dialogs to support voice-based search by users. Each navigation tree may comprise a number of content nodes and routing nodes. Content nodes contain or are associated with content from a web page that can be delivered to a user. Content included or associated with a node is stored in the form of electrical signals on a storage medium such that when a node is visited by a user the content is accessible by a user. Routing nodes implement options that can be selected to move to other nodes. For example, routing nodes may provide prompts for directing the user to content at content nodes. Thus, routing nodes link the content of a web page in a meaningful way. Navigation trees are described in more detail herein.

Voice browsing system 10 thus provides a technical advantage. A voice-based browser is crucial for users having limited display devices 18 since a visual browser is inappropriate for, or simply cannot work with, such devices. Furthermore, voice browsing system 10 leverages on the existing content infrastructure (i.e., documents formatted in conventional markup languages, such as, HTML or XML) maintained by content providers 12. That is, the existing content infrastructure can serve as an easy-to-administer, single source for interaction by both complete computer systems (e.g., desktop computer) and limited display devices 18 (e.g., wireless telephones or wireless PDAs). As such, content providers 12 are not required to re-create their content in other formats, deploy new markup languages (e.g., VoiceXML), or implement additional application programming interfaces (APIs) into their back-end systems to support other formats and markup languages.

Another Exemplary Environment

FIG. 11B illustrates another exemplary environment within which a voice browsing system 10, according to an embodiment of the invention, can operate. In this environment, voice browsing system 10 may be implemented within the system of a content provider 12. Content provider 12 can be substantially similar to that previously described with reference to FIG. 1A. That is, content provider 12 can be an entity which operates or maintains a portal or any other web site through which content can be delivered. Such content can be included in one or more web pages of the respective portal or web site maintained by content provider 12.

Each web page can be supported by documents formatted in a conventional markup language, such as Hyper-Text Markup Language (HTML) or eXtensible Markup Language (XML). Along with the conventional markup language documents, content provider 12 may also maintain one or more style sheet (e.g., extended Cascading Style Sheet (xCSS)) documents containing metadata that can be used to guide the construction of a semantic representation for the content.

A network 20 is coupled to content provider 12. Network 20 can be any suitable network for communicating data and information. This network can be a telecommunications or other network, as described with reference to FIG. 1A, supporting telephony and voice services, including plain old telephone service (POTS), digital services, cellular service, wireless service, pager service, etc.

A number of limited display devices 18 are coupled to network 20. These limited display devices 18 can be substantially similar to those described with reference to FIG. 1A. That is, each limited display device 18 may comprise a communication device with limited capability for visual display, such as, for example, a wired telephone, a wireless telephone, a smart phone, or a wireless personal digital assistant (PDA). Each limited display device 18 supports communication by a respective user, for example, in the form of speech, voice, or other audible information.

In operation for this environment, voice browsing system 10 again generally functions to allow users with limited display devices 18 to browse content provided by one or more content providers 12 using, for example, spoken/voice commands or requests. In this environment, however, because voice browsing system 10 is incorporated at content provider 12, content provider 12 may directly receive, process, and respond to these spoken/voice commands or requests from users. For each command/request, voice browsing system 10 retrieves the desired content and other information at content provider 12. The content can be in the form of markup language (e.g., HTML or XML) documents, and the other information may include metadata in the form of style sheet (e.g., xCSS) documents. Voice browsing system 10 may construct or generate navigation trees using the style sheet documents to supply metadata to the conventional markup language documents. These navigation trees then serve as interactive menu dialogs to support voice-based search by users.

Voice Browsing System

FIG. 2 is a block diagram of a voice browsing system 10, according to an embodiment of the invention. In general, voice browsing system 10 allows a user of a limited display device 18 to browse the content available from any one or more content providers 12 using spoken/voice commands or requests. As depicted, voice browsing system 10 includes a gateway module 30 and a browser module 32.

Gateway module 30 generally functions as a gateway to translate data/information between one type of network/computer system and another, thereby acting as an interface. In the context for the invention, gateway module 30 translates data/information between a network supporting limited display devices 18 (e.g., a telecommunications network) and the computer-based system of voice browsing system 10. For the network supporting the limited display devices, data/information can be in the form of speech or voice.

The functionality of gateway module 30 can be performed by one or more suitable processors, such as a main-frame, a file server, a work station, or other suitable data processing facility supported by memory (either internal or external), running appropriate software, and operating under the control of any suitable operating system (OS), such as MS-DOS, Macintosh OS, Windows NT, Windows 95, OS/2, Unix, Linux, Xenix, and the like. Gateway module 30, as shown, comprises a computer telephony interface (CTI)/personal digital assistant (PDA) component 34, an automated speech recognition (ASR) component 36, and a text-to-speech (TTS) component 38. Each of these components 34, 36, and 38 may comprise one or more programs which, when executed, perform the functionality described herein. CTI/PDA component 34 generally functions to support communication between voice browsing system 10 and limited display devices. CTI/PDA component 34 may comprise one or more application programming interfaces (API) for communicating in any protocol suitable for public switch telephone network (PSTN), cellular telephone network, smart phones, pager devices, and wireless personal digital assistant (PDA) devices. These protocols may include hypertext transport protocol (HTTP), which supports PDA devices, and PSTN protocol, which supports cellular telephones.

Automated speech recognition component 36 generally functions to recognize speech/voice commands and requests issued by users into respective limited display devices 18. Automated speech recognition component 36 may convert the spoken commands/requests into a text format. Automated speech recognition component 36 can be implemented with automatic speech recognition software commercially available, for example, from the following companies: Nuance Corporation of Menlo Park, Calif.; Speech Works International, Inc. of Boston, Mass.; Lernout & Hauspie Speech Products of leper, Belgium; and Phillips International, Inc. of Potomac, Md. Such commercially available software typically can be modified for particular applications, such as a computer telephony application.

Text-to-speech component 36 generally functions to output speech or vocalized messages to users having a limited display device 18. This speech can be generated from content that has been retrieved from a content provider 12 and reformatted within voice browsing system 10, as described herein. Text-to-speech component 38 synthesizes human speech by “speaking” text, such as that which can be part of the content. Software for implementing text-to-speech component 76 is commercially available, for example, from the following companies: Lemout & Hauspie Speech Products of leper, Belgium; Fonix Inc. of Salt Lake City, Utah; Centigram Communications Corporation of San Jose, Calif.; Digital Equipment Corporation (DEC) of Maynard, Mass.; Lucent Technologies of Murray Hill, N.J.; and Microsoft Inc. of Redmond, Wash.

Browser module 32, coupled to gateway module 30, functions to provide access to web pages (of any one or more content providers 12) using Internet protocols and controls navigation of the same. Browser module 32 may organize the content of any web page into a structure that is suitable for browsing by a user using a limited display device 18. Afterwards, browser module 32 allows a user to browse such structure, for example, using voice or speech commands/requests.

The functionality of browser module 32 can be performed by one or more suitable processors, such as a main-frame, a file server, a work station, or other suitable data processing facility supported by memory (either internal or external), running appropriate software, and operating under the control of any suitable operating system (OS), such as MS-DOS, Macintosh OS, Windows NT, Windows 95, OS/2, Unix, Linux, Xenix, and the like. Such processors can be the same or separate from that which perform the functionality of gateway module 30.

As depicted, browser module 32 comprises a navigation tree builder component 40 and a navigation agent component 42. Each of these components 40 and 42 may comprise one or more programs which, when executed, perform the functionality described herein.

Navigation tree builder component 40 may receive conventional, Internet-accessible markup language (e.g., XML or HTML) documents and associated style sheet (e.g., xCSS) documents from one or more content providers 12. Using these markup language and style sheet documents, navigation tree builder component 40 generates navigation trees that are semantic representations of web pages. In general, each navigation tree provides a hierarchical menu by which users can readily navigate the content of a conventional markup language document. Each navigation tree may include a number of nodes, each of which can be either a content node or a routing node. A content node comprises content that can be delivered to a user. A routing node may implement a prompt for directing the user to other nodes, for example, to obtain the content at a specific content node.

Navigation agent component 42 generally functions to support the navigation of navigation trees once they have been generated by navigation tree builder component 40. Navigation agent component 42 may act as an interface between browser module 32 and gateway module 30 to coordinate the movement along nodes of a navigation tree in response to any commands and requests received from users.

In exemplary operation, a user may communicate with voice browsing system 10 to obtain content from content providers 12. To do this, the user, via limited display device 18, places a call which initiates communication with voice browsing system 10, as supported by CTI/PDA component 34 of gateway module 30. The user then issues a spoken command or request for content, which is recognized or interpreted by automatic speech recognition component 36. In response to the recognized command/request, browser module 32 accesses a web page containing the desired content (at a web site or portal operated by a content provider 12) via Internet 14 or other communication network. Browser module 32 retrieves one or more conventional markup language and associated style sheet documents from the content provider.

Using these markup language and style sheet documents, navigation tree builder component 40 creates one or more navigation trees. The user may interact with voice browsing system 10, as supported by navigation agent component 42, to navigate along the nodes of the navigation trees. During navigation, gateway module 30 may convert the content at various nodes of the navigation trees into audible speech that is issued to the user, thereby delivering the desired content. Browser module 32 may generate and support the navigation of additional navigation trees in the event that any other command/request from the user invokes another web page of the same or a different content provider 12. When a user has obtained all desired content, the user may terminate the call, for example, by hanging up.

Navigation Tree Builder Component

FIG. 3 is a block diagram of a navigation tree builder component 40, according to an embodiment of the invention. Navigation tree builder component 40 generally functions to construct navigation trees 50 which can be used to readily and orderly provide the content of respective web pages to a user via a limited display device 18. As depicted, navigation tree builder 40 comprises a markup language parser 52, a style sheet parser 54, and a tree converter 56. Each of markup language parser 52, style sheet parser 54, and tree converter 56 may comprise one or more programs which, when executed, perform the functionality described herein.

Markup language parser 52 receives conventional, Internet-accessible markup language (e.g., HTML or XML) documents 58 from a content provider 12. Conventional markup languages describe how content should be structured, formatted, or displayed. To accomplish this, conventional markup languages may embed tags to specify spans, frames, paragraphs, ordered lists, unordered lists, headings, tables, table rows, objects, and the like, for organizing content. Each markup language document 58 may serve as the source for a web page. Markup language parser 52 parses the content contained within a markup language document 58 in order to generate a document tree 60. In particular, markup language parser 52 can map each markup language document into a respective document tree 60.

Each document tree 60 is a basic data representation of content. An exemplary document tree 60 is illustrated in FIG. 5. Document tree 60 organizes the content of a web page based on, or according to, the formatting tags of a conventional markup language. The document tree is a graphic representation of a HTML document. A typical document tree 60 includes a number of document tree nodes. As depicted, these document tree nodes include an HTML designation (HTML), a header (<HEAD>) and a body (<BODY>), a title (<TITLE>), metadata (<META>), one or more headings (<H1>, <H2>), lists (<LI>), unordered list (<UL>), a paragraph (<P>). The nodes of a document tree may comprise content and formatting information. For example, each node of the document tree may corresponds to either HTML markup tags or plain text. The content of a markup element appears as its child in the document tree. For example, the header (<HEAD>) may have content in the form of the phrase “About Our Organization” along with formatting information which specifies that the content should be presented as a header on the web page.

Document tree 60 is designed for presenting a number of content elements simultaneously. That is, the organization of web page content according to the formatting tags of conventional markup language documents is appropriate, for example, for a visual display in which textual information can be presented at once in the form of headers, lines, paragraphs, tables, arrays, lists, and the like, along with images, graphics, animation, etc. However, the structure of a document tree 60 is not particularly well-suited for presenting content serially, for example, as would be required for a audio presentation in which only a single element of content can be presented at a given moment.

Specifically, in an audio context, the formatting information of a document tree 60 does not provide meaningful connections or links for the content of a web page. For example, formatting information specifying that content should be displayed as a header does not translate well for an audio presentation of the content. In addition, much of the formatting information of a document tree 60 does not constitute meaningful content which may be of interest to a user. For example, the nodes for header (<HEAD>) and body (<BODY>) are not intrinsically interesting. In fact, the header (<HEAD>)—comprising title (<TITLE>) and metadata (<META>)—does not generally contain information that should be presented directly to the user.

Style sheet parser 54 receives one or more style sheet (e.g., xCSS) documents 62. Style sheet documents 62 provide templates for applying style information to the elements of various web pages supported by respective conventional markup language documents 58. Each style sheet document 62 may supply or provide metadata for the web pages. For example, using the metadata from a style sheet document 62, audio prompts can be added to a standard web page. This metadata can also be used to guide the construction of a semantic representation of a web page.

The metadata may comprise or specify rules which can be applied to a document tree 60. Style sheet parser 54 parses the metadata from a style sheet document 62 to generate a style tree 64. Each style tree 64 may be associated with a particular document tree 60 according to the association between the respective style sheet documents 62 and conventional markup language documents 58. A style tree 64 organizes the rules (specified in metadata) into a structure by which they can be efficiently applied to a document tree 60. A tree structure for the rules is useful because the application of rules can be a hierarchical process. That is, some rules are logically applied only after other rules have been applied.

Tree converter 56, which is in communication with markup language parser 52 and style sheet parser 54, receives the document trees 60 and style trees 64 therefrom. Using the document trees 60 and style trees 64, tree converter 56 generates navigation trees 50. Among other things, tree converter 56 may apply the rules of a style tree 64 to the nodes of a document tree 60 when generating a navigation tree 50. Furthermore, tree converter 56 may apply other rules (heuristic rules) to each document tree, and thereafter, may map various nodes of the document tree into nodes of a navigation tree 50.

A navigation tree 50 organizes content of a conventional markup language document 58 into a hierarchical or outline structure. With the hierarchical structure, the various elements of content are separated into various levels (e.g., parts, sub-parts, sub-sub-parts etc.). Appropriate mechanisms are provided to allow movement from one level to another and across the levels. The hierarchical arrangement of a navigation tree 50 is suitable for presenting content sequentially, and thus can be used for “semantic” retrieval of the content at a web page. As such, the navigation tree 50 can serve as an index that is suitable for browsing content using voice commands.

An exemplary navigation tree 50 is illustrated in FIG. 6. A navigation tree 50 is, in general, made up of routing nodes and content nodes. Content nodes may comprise content that can be delivered to a user. Content nodes can be of various types, such as, for example, general content nodes, table nodes, and form nodes. Table nodes present a table of information. Form nodes can be used to assist in the filling out of respective forms. Routing nodes are unique to navigation trees 50 and are generated according to rules applied by tree converter 56.

Routing nodes direct navigation between nodes by providing logical connections between them. The routing nodes are interconnected by directed arcs (edges or links). These directed arcs are used to construct the hierarchical relationship between the various nodes in the navigation tree 50. That is, these arcs specify allowable navigation traversal paths to move from one node to another. In FIG. 6, for example, an unordered list node UL is a routing node for moving to list nodes <LI1> or <LI2>. The options for other nodes may be explicitly included in the routing node.

Content nodes, in certain but not all embodiments, are reachable by tree traversal operations. For example, in some embodiments, the data found in content nodes is accessed through a parent routing node called a group node <P>. The group node organizes content nodes into a single presentational unit. The group node can be used for organizing multi-media content. For example, rather than present text and links as disjointed content, a group node can be used to organize a collection of text, audio wave files, and URI links together such as the following:

For more information about <A href =
“http:///www.vocalpoint.com/sound.wav”>vocalpoint </A>, send
email to: <A href = info@vocalpoint.com> info@vocalpoint.com
</A>.

As such, routing nodes provide the nexus or connection between content nodes, and thus provide meaningful links for the content of a web page. In this way, routing nodes support or provide a semantic, hierarchical relationship for web page content in a navigation tree 50. An exemplary object-oriented implementation for routing and content nodes of a navigation tree is provided in attached Appendix A and FIG. 9.

In one embodiment, a navigation tree 50 can be used to define a finite state machine. In particular, various nodes of the navigation tree may correspond to states in the finite state machine. Navigation agent component 42 may use the navigation tree to directly define the finite state machine. The finite state machine can be used by navigation agent 42 of browser module 32 to move throughout the hierarchical structure. At any current state/node, a user can advance to another state/node.

Tree Converter

FIG. 4 is a block diagram of a tree converter 56, according to an embodiment of the invention. Tree converter 56 generally functions to convert document trees 60 into navigation trees 50, for example, using style trees 64. As depicted, tree converter 56 comprises a style sheet engine 68, a heuristic engine 70, and a mapping engine 72. Each of style sheet engine 68, heuristic engine 70, and mapping engine 72 may comprise one or more programs which, when executed, perform the functionality described herein.

Style sheet engine 68 generally functions to apply style sheet rules to a document tree 60. Application of style sheet rules can be done on a rule-by-rule basis to all applicable nodes of the document tree 60. These style sheet rules can be part of the metadata of a style sheet document 62. Each style sheet rule can be a rule generally available in a suitable style sheet language of style sheet document 62.

In one embodiment, these style sheet rules may include, for example, clipping, pruning, filtering, and converting. In a clipping operation, a node of a document tree is marked as special so that the node will not be deleted or removed by other operations. Clipping may be performed for content that is important and suitable for audio presentation (e.g., text which can be “read” to a user). In a pruning operation, a node of a document tree is eliminated or removed. Pruning may be performed for content that is not suitable for delivery via speech or audio. This can include visual information (e.g., images or animation) at a web page. Other content that can be pruned may be advertisements and legal disclaimers at each web page.

In a filtering operation, auxiliary information is added at a node. This auxiliary information can be, for example, labels, prompts, etc. In a conversion operation, a node is changed from one type into another type. For example, some content in a conventional markup language document can be in the form of a table for presenting information in a grid-like fashion. In a conversion, such table may be converted into a routing node in a navigation tree to facilitate movement among nodes and to provide options or choices.

As depicted, style sheet engine 68 comprises a selector module 74 and a rule applicator module 76. In general, selector module 74 functions to select or identify various nodes in a document tree 60 to which the rules may be applied to modify the tree. After various nodes of a particular document tree 60 have been selected by selector module 74, rule applicator module 76 generally functions to apply the various style tree rules (e.g., clipping, pruning, filtering, or converting) to the selected nodes as appropriate in order to modify the tree.

Heuristic engine 70 is in communication with style sheet engine 68. Heuristic engine 70 generally functions to apply one or more heuristic rules to the document tree 60 as modified by style sheet engine 68. In one embodiment, these heuristic rules may be applied on a node-by-node basis to various nodes of document tree 60. Each heuristic rule comprises a rule which may be applied to a document tree according to a heuristic technique.

A heuristic technique is a problem-solving technique in which the most appropriate solution of several found by alternative methods is selected at successive stages of a problem-solving process for use in the next step of the process. In the context of the invention, the problem-solving process involves the process of converting a document tree 60 into a navigation tree 50. In this process, heuristic rules are selectively applied to a document tree after the application of style sheets rules and before a final mapping into navigation tree 50, as described below).

In one embodiment, heuristic rules may include, for example, converting paragraph breaks and line breaks into space breaks (white space), exploiting image alternate tags, deleting decorative nodes, merging content and links, and building outlines from headings and ordered lists. The operation for converting paragraph breaks and line breaks into space breaks is done to eliminate unnecessary formatting in the textual content at a node while maintaining suitable delineation between elements of text (e.g., words) so that the elements are not concatenated. The operation for exploiting image alternative tags identifies and uses any image alternative tags that may be part of the content contained at a particular node.

An image alternative tag is associated with a particular image and points to corresponding text that describes the image. Image alternative tags are generally designed for the convenience of users who are visually impaired so that alternative text is provided for the particular image. The operation for deleting decorative nodes eliminates content that is not useful in a navigation tree 50. For example, a node in the document tree 60 consisting of only an image file may be considered to be a decorative node since the image itself cannot be presented to a user in the form of speech or audio, and no alternative text is provided. The operation for merging content and links eliminates the formatting for a link (e.g., a hypertext link) is done so that the text for the link is read continuously as part of the content delivered to a user.

The operation for building or generating outlines from headings and ordered lists is performed to create the hierarchical structure of the navigation tree 50. A headline—which can be, for example, a heading for a section of a web page—is identified by suitable tags within a conventional markup language document. In a visually displayed web page, multiple headings may be provided for a user's convenience. These headings may be considered alternatives or options for the user's attention. An ordered list is a listing of various items, which in some cases, can be options. Heuristic engine 70 may arrange or organize headings and ordered lists so that the underlying content is presented in the form of an outline.

Mapping engine 72 is in communication with heuristic engine 70. In general, mapping engine 72 performs a mapping function that changes certain elements in a modified document tree 60 into appropriate nodes for a navigation tree 50. Mapping engine 72 may operate on a node-by-node basis to provide such mapping function. In one embodiment, the content at a node in document tree 60 is mapped to create a content node in the navigation tree 50. Ordered lists, unordered lists, and table rows are mapped into suitable routing nodes of the navigation tree 50.

Any table in document tree 60 may be mapped to create a table node in the navigation tree 50. A form in a document tree 60 can be mapped to create a form node in the navigation tree 50. A form may comprise a number of fields which can be filled in by a user to collect information. Form elements in the document tree 60 can be mapped into a form handling node in navigation tree 50. Form elements provide a standard interface for collecting input from the user and sending that information to a Web server.

Computer-Based System

FIG. 7 illustrates a computer-based system 80 which is an exemplary hardware implementation for voice browsing system 10. In general, computer-based system 80 may include, among other things, a number of processing facilities, storage facilities, and work stations. As depicted, computer-based system 80 comprises a router/firewall 82, a load balancer 84, an Internet accessible network 86, an automated speech recognition (ASR)/text-to-speech (TTS) network 88, a telephony network 90, a database server 92, and a resource manager 94.

These computer-based system 80 may be deployed as a cluster of networked servers. Other clusters of similarly configured servers may be used to provide redundant processing resources for fault recovery. In one embodiment, each server may comprise a rack-mounted Intel Pentium processing system running Windows NT, UNIX, or any other suitable operating system.

For purposes of the invention, the primary processing servers are included in Internet accessible network 86, automated speech recognition (ASR)/text-to-speech (TTS) network 88, and telephony network 90. In particular, Internet accessible network 86 comprises one or more Internet access platform (IAP) servers. Each IAP servers implements the browser functionality that retrieves and parses conventional markup language documents supporting web pages.

Each IAP servers builds the navigation trees 50 (which are the semantic representations of the web pages) and generates the navigation dialog with users. Telephony network 90 comprises one or more computer telephony interface (CTI) servers. Each CTI server connects the cluster to the telephone network which handles all call processing. ASR/TTS network 88 comprises one or more automatic speech recognition (ASR) servers and text-to-speech (TTS) servers. ASR and TTS servers are used to interface the text-based input/output of the IAP servers with the CTI servers. Each TTS server can also play digital audio data.

Load balancer 84 and resource manager 94 may cooperate to balance the computational load throughout computer-based system 10 and provide fault recovery. For example, when a CTI server receives an incoming call, resource manager 94 assigns resources (e.g., ASR server, TTS server, and/or IAP server) to handle the call. Resource manager 94 periodically monitors the status of each call and in the event of a server failure, new servers can be dynamically assigned to replace failed components. Load balancer 84 provides load balancing to maximize resource utilization, reducing hardware and operating costs.

Computer-based system 80 may have a modular architecture. An advantage of this modular architecture is flexibility. Any of these core servers—i.e., IAP servers, CTI servers, ASR servers, and TTS servers—can be rapidly upgraded ensuring that voice browsing system 10 always incorporate the most up-to-date technologies.

Method For Browsing Content With Voice Commands

FIG. 8 is a flow diagram of an exemplary method 100 for browsing content with voice commands, according to an embodiment of the invention. Method 100 may correspond to an aspect of operation of web browsing system 10, in which a navigation tree is generated as a map for the content. The navigation tree is then used for browsing the content. FIG. 9 is a block diagram of an exemplary navigation tree 1020 comprising a plurality of branches extending from a root node 1021.

Each branch may comprise or connect one or more nodes, including routing nodes, group nodes, and/or content nodes. Routing Nodes 1, 2, and 3, which can be “children” of root node 1021, form or define three branches of navigation tree 1020. Each branch, for example, includes group nodes and content nodes implemented to form sub-branches and “leaves” for tree 1020. The routing nodes include information that allows a user to traverse navigation tree 1020 based on the content included in the content nodes.

Referring again to FIG. 8, method 100 begins at step 102 where voice browsing system 10 receives at gateway module 30 a call from a user, for example, via a limited display device 18. In the call, the user either issues a command or submits a request or is prompted to provide a response. The terms “response,” “command,” and “request” that indicate the interaction of the user with the system are used interchangeably throughout the document. For simplicity and consistency, however, the term “request” is primarily used hereafter to refer to any user interaction with the system. This usage should not, however, be construed as a limitation. A user request can be in the form of voice or speech and may pertain to particular content.

This content may be contained in a web page at a web site or portal maintained by a content provider 12. The content can be formatted in HTML, XML, or other conventional markup language format. Automatic speech recognition (ASR) component 36 of gateway module 30 operates on the voice/speech to recognize the user request for content, for example. Gateway module 30 forwards the request to browser module 32. By way of example, one or more embodiments of the system have been described as applicable to a voice browsing system. This application, however, is exemplary and should not be construed as a limitation. The user may interact with the system via any interactive communication interface (e.g., graphic interface, touch tone interface).

At step 104, responsive to the user request, voice browsing system 10 initiates a web browsing session to provide a communication interface for the user. At step 106, browser module 32 loads or fetches a markup language document 58 supporting the web page that contains the desired content. This markup language document can be, for example, an HTML or an XML document. Browser module 32 may also load or retrieve one or more style sheet documents 62 which are associated with the markup language document 58.

At step 108, browser module 32 adds an identifier (e.g., a uniform resource locator (URL)) for the web page to a list maintained within voice browsing system 10. This is done so that voice browsing system 10 can keep track of each web page from which it has retrieved content; thus, at least some of the operations which voice browsing system 10 performs for any given web page in response to an initial request do not need to be repeated in response to future requests relating to the same web page.

At step 110, navigation tree builder component 40 of browser module 32 builds a navigation tree 1020 for the target web page. In one embodiment, to accomplish this, navigation tree builder component 40 may generate a document tree 60 from the conventional markup language document 58 and a style tree 64 from the style sheet document 62. The document tree 60 is then converted into a navigation tree (e.g., navigation tree 1020), in part, using the style tree 64. The navigation tree 1020 provides a semantic representation of the content contained in the target web page that is suitable for voice or audio commands.

The navigation tree 1020 includes a plurality of nodes, as shown in FIG. 9. Each node either contains or is associated with certain content of the target web page. Each node further includes or is associated with commands, keywords, and/or phrases that correspond with the web page content. The terms “commands,” “keywords,” and “phrases” may be used interchangeably throughout the document. For simplicity and consistency, the term “keyword” has been used, when proper, to refer to one or all the above collectively. This usage, however, should not be construed to limit the scope of the invention.

Keywords are used to identify and classify the respective nodes based on contents of the nodes and to allow a user to browse the content of the web page. Further, these keywords are also used by the system to build prompts or greetings for each node, when a node is visited. As provided in further detail below, the system in certain embodiments, also uses the keywords to build a dynamic navigation grammar with vocabulary that is expanded or narrowed based on the hierarchical position of nodes in instance of navigation. The grammar built at each navigation instance is specific to the user and the navigation route selected by the user at that instance. As such, in one or more embodiments of the system, each node visited in a navigation route corresponds with a navigation instance represented by a unique navigation grammar for that node at that instance.

The system 10 utilizes the navigation grammar to recognize a user request for access to the content included or associated with various nodes in the navigation tree 1020. Using voice commands, in one embodiment, a user may direct the system to do the following, for example: browse the content of a web page, jump to a specific web page, move forward or backwards within one or more web pages or websites, make a selection from the content of a web page, fill out specific fields in a web page, or confirm selections or inputs to a web page. Furthermore, navigation tree 1020 may provide a user with the means to readily browse the content of a web page by submitting voice requests, as provided in further detail below.

At step 112, navigation agent component 42 of browser module 32 begins traversing navigation tree 1020 by setting root node 1021 as the node being currently visited. Root node 1021, in accordance with one aspect of the invention, is a routing node that can comprise a number of different options from which a user can select, for example, to obtain content or to move to another node. To present these various options to the user, text-to-speech (TTS) component 38 of gateway module 30 may generate speech for the options, which is then delivered to the user via limited display device 18. For example, a greeting may be played to notify the user of the name, nature, or content of the web site or web page accessed, followed by a list of selectable options, such as weather, sports, stock quotes, and mail. The user may then select one of the presented options, for example, by issuing a request which is recognized by automatic speech recognition component 36.

At step 114, browsing module 32 browses (i.e., visits or moves to) the node in navigation tree 1020 that corresponds with the selected option by the user. When the browsing module 32 visits a node, the browsing module 32 retrieves information included in the node to determine the node type (e.g., routing node, content node, form node, etc.) and/or the content included or referenced by the node. For example, referring to FIG. 9, if in the above example the user selects the “weather” option, then browsing module 32 visits Routing Node 1 if that node is associated with weather information. A search table or alternate data structure may be utilized to store information about the content and type of nodes included in the tree, so that node searches and selections are performed more efficiently by referencing the table, for example. If Routing Node 1 is not associated with the selected option, the rest of the nodes in the tree (or the corresponding data structure including node information) are searched to find the proper node to visit.

At step 124, navigation agent component 42 determines whether the current node is a routing node. If so, then the system moves to step A to process the content of that node and its children, if any. A routing node is a node that may comprise a plurality of options from which the user may select in order to navigate or move from one node to another. For example, in FIG. 9, if Routing Node 2 is the routing node associated with the “sports” option, then it can include children nodes that provide further options in the sports category. For example, Routing Nodes 2.1 and 2.3 may reference group nodes that include information about “football” and “basketball,” respectively. Thus, processing Routing Node 2.1 will provide information related to football games, such as, for example, team scores and standing, while processing Routing Node 2.3 will provide information related to basketball games. Routing Node 2 may also reference a Content Node 2.2 that includes content such as a calendar of sports events, for example.

Referring back to FIG. 8, if it is determined at step 124 that the current node is not a routing node, then at step 126 browser module 32 determines, based on type information associated with the node, whether the current node is a form node. If so, then the system moves to step B. A form node is a node that relates to an electronic form implemented for collecting information—typically information of textual nature such as name, telephone number, and address. Such form may comprise a number of fields for separate pieces of information that can be edited by a user. For example, an order form may be edited as part of an electronic transaction via a web site or portal associated with content provider 12.

At step 126, if it is determined that the current node is not a form node, then the system moves to step 136, and voice browsing system 10 determines whether the current node is a content node. A content node generally includes information or content that can be presented to a user. If the current node is a content node, then at step C voice browsing system 10 plays the content to the user. The content of a content node may be provided to the user in one or more ways. For example, one embodiment of the system, uses text-to-speech component 38 to play the content of a node to a user. The text-to-speech component 38 is provided herein by way of example. Other ways for conveying or playing the content to the user may be utilized.

If, at step 136, it is determined that the current node is not a content node, then at step 144 voice browsing system 10 determines whether the current node is unknown to the system. A node may be unknown to the system due to an error in the system, or if the web page associated with that node is not valid or available. If the current node is unknown, then voice browsing system 10 may deliver an appropriate message or prompt for notifying the user of such fact.

In certain embodiments, if the current node is unknown, at step 146 voice browsing system 10 computes the next page to be presented to a user. This page may be implemented to inform the user that the current selection or request is not appropriate or available. Alternatively, the next page may be chosen by the system as the page that can be most closely matched with the user request. After the next page has been computed, method 100 moves to step 106, to fetch or retrieve the conventional markup language document 58 supporting the computed next page.

At step 148, it is determined whether the current interactive session with the user should be ended. A session is terminated if, for example, a predetermined time has elapsed in which a user has either not submitted a request or not provided a response to a system prompt. Alternatively, a user may actively taken action to end the session by, for example, terminating the communication connection. At step 148, if the session is not ended, then method 100 returns the user to the main menu or other node in navigation tree 1020.

Various steps in method 100 may be repeated throughout an interactive session to generate one or more navigation trees 1020 and allow a user to obtain content and to traverse the nodes within each navigation tree 1020. As such, a user is able to browse the content available at the web pages of a web site or portal maintained by content provider 12 using voice, tone, or other interface commands. Method 100 can be implemented to comply with the existing infrastructure of conventional markup language documents of a web site. Accordingly, content provider 12 is not required to set up and maintain a separate site in order to provide access and content to users.

Method For Navigating a Routing Node

Referring to FIGS. 8 and 10, once the system at step 124 determines that the visited node is a routing node, then at step 1305 the system initializes the counters for that node. In accordance with one aspect of the invention, each node, particularly each routing node, is associated with one or more counters. These counters include a help counter, a timeout counter, and a rejection counter.

The help counter keeps track of the number of times help messages are played for a node currently being visited. A help message is usually provided to the user in case the system does not recognize the user's request or at the user's request. Thus, the help counter is incremented until the system successfully moves to the next node or the session ends. If the system browses that node again at a later time, then the counter would be reset, at step 1305.

A timeout counter keeps track of the number of times the system does not receive or recognize a user request while visiting the current node. In one or more embodiments, the system allows the user to submit a request or provide a response to a prompt within a certain number of seconds. If no request is submitted by the user, or if the delay in providing the request is longer than the allotted threshold, then the system plays a timeout message and increments the timeout counter. The timeout counter is incremented for the current node until the system successfully moves to the next node or the session ends. If the system browses that node again at a later time, then the counter would be reset at step 1305.

The rejection counter is a counter that keeps track of the number of times one or more user requests are rejected by the system while visiting the current node. A user request can be rejected by the system if the system does not recognize the request or if the system attempts to correct or resolve any ambiguity related to (i.e., disambiguate) an unacceptable or unrecognizable request. The rejection counter is incremented for the current node until the system successfully moves to the next node or the session ends. If the system browses that node again at a later time, then the counter would be reset at step 1305. The help, timeout, and rejection counters are incremented by a constant value (e.g., one), whenever help, timeout, or rejection messages are played.

Referring back to FIG. 10, at step 1310, the system determines whether an explicit greeting is included in the routing node visited by the system. An explicit greeting is a greeting that is included in the routing node when the navigation tree is built. An explicit greeting is played verbatim from the node. Referring to FIG. 9, for example, if Routing Node 1 is associated with a web page that includes information about the weather, then an explicit greeting may be included in Routing Node 1 that would welcome the user and indicate to the user that weather information can be obtained at this node. An exemplary greeting for such node would be: “Weather information.” In one embodiment, an explicit greeting is included in the node when navigation tree 1020 is being generated.

If at step 1310, the system determines that an explicit greeting is not included in the routing node, then at step 1315 the system builds a greeting based on the keywords included in or associated with the routing node. For example, if Routing Node 1 is associated with a web page that includes weather information, then in accordance with one embodiment of the system, when the navigation tree is built, a keyword such as, for example, “weather” is included in or associated with Routing Node 1. This keyword is chosen based on the attributes and properties defined for that node in the style sheet. The keyword may also be automatically generated by analyzing the content of the HTML page. To build a greeting, at step 1315, the system may include the keyword (in this case “weather”) in a default greeting phrase. For example, a greeting for Routing Node 1 may be “Weather Information” wherein the additional phrase “Information” is added to the keyword “weather” by default.

Once a greeting has been built by the system, then the system moves to step 1320 to determine whether an explicit prompt is included in the routing node. A prompt is typically provided to the user to elicit a response. An explicit prompt is played verbatim by the system. For example, an explicit prompt for Routing Node 1 could be “What city's weather are you checking?” Alternatively, in some embodiments of the invention, a prompt may provide a user with a list of choices from which to choose. For example, the following prompt may be provided: “Choose weather for Los Angeles, New York, or Dallas.” If an explicit prompt is not included in the routing node, then at step 1325, the system builds a prompt based on keywords included in the routing node. The prompt built by the system could be, for example, “What city, please?” or “Choose weather for Los Angeles, New York, or Dallas.” In certain embodiment, the manner in which prompts are built are based on the attributes and properties defined in the style sheet.

Once the system has determined the greeting and the prompt for the current node, then at step 1330 the system builds a default navigation grammar. The default navigation grammar includes default vocabulary and corresponding rules defining navigation behavior. The default vocabulary includes keywords that are commonly used to navigate the nodes of the navigation tree or perform operations that correspond with certain tree features. Examples of such navigation commands are: “Next,” “Previous,” “Goto,” “Back,” and “Home.” Using these keywords, a user may direct a system to perform the following operations, for example: browse the content of a web page, jump to a specific web page, move forward or backward within a web page or between web pages, make a selection from the content in a web page, fill out specific fields in a web page, or confirm selections and input to a web page.

Certain commands may allow the user to change certain node attributes or characteristic. For example, a user may in accordance with one embodiment delete or add content to a node, or even delete or add a node to the navigation tree by utilizing commands such as “add” or “delete,” for example. It should be understood that said keywords are provided by way of example and that other vocabulary may be used to perform same or other operations. Each operation may be associated with a certain command. In some embodiments, the default vocabulary may be built so that more than one keyword is associated with a single operation. For example, the keywords “Goto, Jump, or Move to” may all be used to command the system to visit another node.

A default grammar, in one embodiment, is built prior to a node being visited instead of being built at the time the node is visited. Referring back to FIG. 10, after the default navigation grammar is built, at step 1335, the system determines whether the routing node has a child. If so, at step 1340, the system adds the keywords associated with the child to the grammar's vocabulary. For example, referring to FIG. 9, Routing Node 1 may have a child node that includes information about the weather conditions in the most popular cities in the world. The child node, for example, may include the phrase “World Weather.” In this example, keywords “world” and “weather” are added to the node's grammar, at step 1340. If a keyword is added to a node's grammar, then a request submitted to the system including that keyword is recognized while the user is visiting that node.

In certain embodiments, the navigation grammar is built dynamically for each node at the time the node is visited. That is, each individual node is associated with a unique grammar. Thus, a keyword included in one node's grammar may not be recognized by the system, while a user is visiting another node. In other embodiments, a global grammar is dynamically built as the tree branches are navigated forward or traversed backward. That is, when a new node is visited, the keywords included in the current node are added to a global grammar. A global grammar is not uniquely assigned to an individual node, but is shared by all the nodes in the navigation tree. Thus, when a keyword is added to the grammar, then a user request including that keyword may be recognized while the user is visiting any node in the navigation tree.

In certain embodiments, the dynamically built grammar is not associated with all the nodes in the tree, but only those that are visited up to a certain point in time. That is, the grammar's vocabulary corresponds with the hierarchical position of a node in the navigation tree. Thus, while the navigation tree is navigated towards the leaves of the tree the vocabulary is expanded as keywords are dynamically added to it for each node visited. Conversely, while the navigation tree is traversed towards the root of the navigation tree, the vocabulary is narrowed as keywords associated with the nodes on the path of reverse traverse are deleted from the vocabulary.

At step 1345, the system verifies whether the current node has another child. If so, the system repeats step 1340 for that child as described above, by for example including the keywords associated with that child to the grammar's vocabulary. If at step 1335, the system determines that the current node has no children or at step 1345 the system determines that the current node has no more children, then the system moves to step 1350 and plays the greeting for the current routing node. In certain embodiments of the invention, the system is implemented to listen while playing the greeting for any user requests, utterances, or inputs. As such, at step 1355, if the system determines that the user is attempting to interact with the system, the system stops playing the greeting and services the user input or request.

The act of a user interrupting the system while the system is playing a greeting or a prompt is referred to as “barging in.” Thus, if while the system at step 1350 is playing the greeting “Weather information,” the user interrupts the system by barging in and saying the key phrase “World Weather,” for example, then the system would skip over step 1360 and directly go to step 1365 and play a list of choices based on the navigation grammar available at that point of navigation. For example, the system may provide the user with the following list: “Los Angeles, New York, Dallas, Tokyo, Frankfurt.” If the user does not barge in at step 1355, however, then the system moves to step 1360 and plays the prompt for the current routing node, before playing the list at step 1365.

The prompt may be an exclusive prompt or a general prompt created by the system, as discussed earlier. A general prompt, for example, may say “Choose from the following” Once the system has played the prompt at steps 1360, then at step 1365 the system plays a list of choices based on the navigation grammar for the current node, as provided above. Thereafter, the system waits for the user's response.

Method For Navigating a Form Node

Referring to FIGS. 8 and 11, once the system at step 126 determines that the current node is a form node, then at step 1405 it initializes the counters for that node, as discussed earlier. A form node includes one or more fields that can be edited by the user. The system, at step 1410, determines whether the form node is a navigable node. A form node is navigable if the user can choose the order in which the fields are visited. In embodiments of the system, a form node includes information (e.g., a tag) that indicates whether the node is navigable.

A form node is non-navigable, if the user has to go through each field in the form before it can exit that node. For example, a user may have to edit a form including fields for first name, last name, address, and telephone number. In a navigable form, the user may have the choice to go to the name field first, the telephone field second, the address field third, and skip over the last name field. In a non-navigable form, the user will have to, for example, start with the name field first, then proceed to the last name field, and thereon to the other fields in the form node in the order provided by the system.

Thus, at step 1410, if the system determines that the form node is navigable, then the system moves to step 1415 and plays the greeting for that node. For example, the greeting may provide “Registration Form.” In one embodiment, the system at step 1425 prompts the user to select a field to visit. At step 1435, the system listens for the selection. At step 1445, the system goes to the field selected by the user. As discussed earlier, at steps 1420 and 1430, the user may barge in to interrupt the system from playing a greeting or prompt. If the user's request or response includes a keyword recognized by the system for a specific field within the form node, then at step 1445 the system goes to the selected field.

If the user request, however, includes a keyword that indicates that the user has completed editing the form, then the system at step 1440 determines that the user is done. The system then moves to step 1470 to submit the form and play a prompt indicating that the task has been completed. The submission of the form may be performed in a well-known manner by including the submitted information in a communication packet and sending it to a destination.

Referring back to step 1445, when the system goes to a selected field requested by the user, then at step 1450 the system collects the input based on the input interface implemented for that field. Various methods may be used to collect input for a field in a form node. The form node may include various field types such as, text, check box, drop down menu, or another type of input field. In certain embodiments, an input field is associated with one or more counters in the same manner that a node in the navigation tree is associated with help, rejection, and timeout counters. These counters are reset when a field is visited and are incremented by a constant value every time the system provides a help, timeout, or rejection message for the field, until the next field is visited or the input session is aborted.

When a field is visited, a greeting for the field is selected. This greeting may be an explicit or general greeting depending on implementation. For example, a greeting played for a text field may be “Enter first name.” The greeting for a check box may be “Select one or more of the following two options.” And, the greeting for a drop down menu may be “Select one of the following options.” Once the greeting is selected, the system then determines if the field includes or is associated with a default value. For example, a check box field may include a default value indicating that the check box is checked. If so, a prompt is built for that field by the system to indicate the status of the check box, for example. Alternatively, a prompt may be built for the field based on an explicit prompt provided for that field or based on keywords associated with the prompt. For example, a prompt for a check box field in a registration form relating to marriage status may indicate: “The check box for ‘Single’ is already checked, please say uncheck if you are married.”

Once the greeting and the prompt are determined for a field, then the system builds a navigation grammar for that field or for the form node being visited. The default navigation grammar for a field includes different or additional vocabulary in comparison to the navigation grammar for a tree. That is, navigation grammar for a field includes vocabulary that suits the functions and procedures associated with editing a field. For example, the grammar vocabulary for navigating among fields in a form may include: “check, uncheck, enter, delete, replace, next, forward, back.” Other words or phrases may be included in the vocabulary in association with edit and navigation rules to allow a user to edit fields or to navigate between fields in a form node.

Once the navigation grammar is built, then the greeting selected for the field is played. The user may choose to barge in either before or after the greeting has been played. The system is implemented to listen for the user's input or commands. If the system recognizes a command to skip the field then the current field is skipped and the system starts over again by resetting the counters for the next field and selecting the appropriate greeting or prompts. If the system recognizes an input for the field then the recognized input is entered into the current field. In certain embodiments of the system, the user is prompted to confirm the input results. For example, if a user after being prompted to provide an input for the check box relating to the user's marriage status, responds “uncheck,” then the system may provide a confirmation message indicating “You have chosen to uncheck single status.” Alternatively, if the user chooses to skip over the field, by for example saying “skip,” then the system would play a message confirming that the user has decided to skip that filed.

Depending on system implementation and type of field being visited, the navigation grammar and confirmation messages may vary to accommodate a user with navigating and editing the form node. Referring back to step 1450 in FIG. 11, once the system has collected the input for a field, then it returns to step 1415 to play the greeting for the next field. In some embodiment, the greeting associated with the form node may also be played, so that the user is reminded of the form that he is editing. Step 1415 may be skipped and the system may move to step 1425 and play the prompt for the next field. The cycle for prompting the user to enter an input and collecting the user's input continues until, at step 1440, the system determines that the user is done with editing the form. The system may determine this by listening for a keyword from the user that indicates he or she is done.

Alternatively, the system may determine that the user is done when all the fields in the form node have been navigated. In certain embodiments, if the user has not provided an input for a field or has failed to visit a field, then the system provides a message indicating the user's deviation. The system may then go to the overlooked field and play the prompt for that field to allow the user to provide the input for that field. When the system determines that the user is done, it then moves to step 1470 to submit the form and play a prompt indicating that the filling of the form has been completed.

In accordance with one aspect of the invention, if the system at step 1410 recognizes that the form node is non-navigable, then it moves to step 1455 and prompts the user to fill out the first field of the form node. A prompt, in some embodiments, is provided to notify the user of the type of information that is expected to be entered in that filed. At step 1460, the system collects the input provided by the user for the field, as discussed above. At step 1465, the system determines if there are any more fields left within the non-navigable form node. If so, the system reverts back to step 1455 and visits the next field. Once the system has exhausted all the fields included in the form node then it moves to step 1470 and submits the form and plays a prompt indicating that the filling of the form has been completed.

Method For Navigating a Content Node

Referring to FIGS. 8 and 12, once the system at step 136 determines that the current node is a content node, then the system moves to step 1505 and initializes the help, rejection, and timeout counters for the content node, as explained earlier with respect to the routing node. Thereafter, the system moves to step 1510 to determine whether the content node includes an explicit greeting. If the node does not include an explicit greeting, then at step 1515, the system builds a greeting based on the keywords associated with the content node. Otherwise, the system moves to step 1520 to determine whether the node includes an explicit prompt. If an explicit prompt is not included, then the system moves to step 1525 to build a prompt based on the keywords included or associated with the content node.

At step 1530, the system builds a default navigation grammar based on the keywords included in or associated with the content node. As discussed above with respect to routing and form nodes, the default navigation grammar may be built prior to a content node being visited. The default vocabulary included in the default navigation grammar is expanded by the system based on the keywords included or associated with nodes visited as the navigation tree is traversed. At step 1535, the system plays the greeting for the content node. At step 1545, the content included in or associated with the content node is played.

Some content nodes include more than one type of content and are referred to as content group nodes. A content node includes only one type of content, for example, text. A group content node, however, may include both text, recorded audio, and/or graphic content. If the current node is a content node, then at step 1545 the system plays the content of the content node. If the content is text, for example, then the system uses text to speech software, for example, to convert and play the content. Other types of information are also converted and played in accordance with the rules defined in the style sheet used to build the navigation tree.

If the current node is a group content node, then at step 1545 the system plays the content of each content type in the order they are included in the node. For example, if the content group includes two different content types: text and audio, then at step 1545 the system plays the text content first and the audio content second, depending on implementation. Alternatively, rather than playing the content automatically, in some embodiments, the system provides the user with a prompt, listing the available content in the group node and asking the user to select the content type the user wishes to be played first. The user may interrupt the system by barging in at step 1540.

Method For Providing User Assistance

FIG. 13 is a flow diagram of an exemplary method 1600 for providing a user with assistance, according to an embodiment of the invention. Method 1600 may correspond to one aspect of operation for voice browsing system 10. A user, while using the system, can request for help at any point during navigation. When a user requests assistance by invoking the help command (e.g., by saying “help”), then at step 1605 the help counter N is incremented. At step 1610, the system retrieves the label for the node currently visited by the user. The node label is associated, in one or more embodiments, with the content of the node and is used to identify that node. The label can be a keyword included or associated with the node, for example.

At step 1615, the system sets a greeting for the current node in accordance to the label. For example, if the user invokes help while visiting a routing node with the label “weather,” then greeting may be set to “Help for weather.” The greeting may also include additional information about the hierarchical position of the node in the navigation tree and other information that may identify the children or parent of the node, for example.

The dynamics and the nature of information associated with each node varies. Therefore, at step 1620, the system determines the type of node being visited so that the appropriate help prompt for that type of node can be set. For example, the system determines if the node is a routing node, form node, or other type of node. Thereafter, based on the type of the node, the system sets a help prompt for the node as indexed by the help counter, at step 1625. If the node is a routing node, the help prompt may be set to indicate the path traversed by the user, or ask the user whether he wishes to visit the children or parents of the present node, for example. If the node is a form node, the help prompt may be set to indicate the number of fields included in the node, or prompt the user to select a field to edit, for example. If the node is a content node, the help prompt may be set to provide a brief description of the content of the node, for example. Additional help features to those discussed here may also be included to guide a user with navigation of the tree.

At step 1630, the system determines whether the help counter is smaller than a threshold value. If so, then the system plays the greeting for that node and plays help prompt N associated with help counter N. Depending on the value of help counter N, the system may provide the user with help prompts that are more or less detailed. For example, in one embodiment of the invention, if the help counter value is equal to 1, then the system may prompt the user with the label of the current node, only. For example, if the current node is a routing node with the label “weather,” then the system may provide the following greeting and prompt: “Help for Weather. Do you wish to continue with weather?” If the user is browsing a registration form node, for example, then the system may provide the user with the following greeting and prompt: “Help for Registration Form. Do you wish to edit this form?”

If after the first help message is provided, the user still needs assistance, then the user may invoke the help command again. Each time the help command is invoked while a certain node is visited, help counter N is incremented at step 1605. As the value of help counter N increases, the system provides the user with a help prompt that is more detailed than the previous one. In some embodiments, a more detailed help prompt may instruct and guide the user to select from one or more options that are available at that navigation instance. For example, if the user is browsing a registration form node and invokes the help command more than once, the system may provide the user with the following greeting and prompt: “Help for Registration Form. This form includes the three following fields: First Name, Last Name, and Telephone Number. Which field would you like to edit first?”

In accordance with one aspect of the invention, the length and complexity of the help prompts gradually increases to provide the user with narrower and more definite options. For example, if the user after hearing a number of detailed help prompts, still invokes the help command, then the system may provide the user with a prompt that limits the user's choice to “yes” or “no” responses. For example, the system may provide the following greeting and prompt: “Help for Registration Form. This form includes the three following fields: First Name, Last Name, and Telephone Number. Would you like to edit the field First Name?” If the user response is “yes,” then the system would provide the user with the option to edit that field, otherwise, the system would provide the user with the name of the next field. The prompts provided above are by way of example only. Other prompt formats and procedures, as suitable for different node types may be implemented and used.

Using the help counter, the system tracks the number of times help messages are played for the current node. The system upon determining that the help counter has reached a predetermined threshold will provide the user at step 1635 with a greeting for the node and playing a last resort help prompt. The last resort help prompt would include instructions to the user about the next step taken by the system. For example, the system may provide the following greeting and last resort help prompt: “Help for Registration Form. No further assistance available for this Registration Form. Returning to the main menu.” Thereafter, the system will return the user to the main menu or other node in the navigation tree.

Method For Recognizing User Requests

FIG. 14 is a flow diagram of an exemplary method 1700 for recognizing user requests. Method 1700 may correspond to one aspect of operation for voice browsing system 10. After the system provides the user with a prompt, then at step 1705 the system listens for a user response to that prompt. In certain embodiments, the system may also be implemented to listen for a user request even before or while a prompt or a greeting is being played. If the system does not receive a user response or request, at step 1710 the system determines whether a timeout condition has been met.

The timeout condition, in one embodiment, is dependent on the amount of time passed before the system recognizes that a request has been submitted by the user. For example, if 5 seconds have passed before a user request is received, then at step 1712 a timeout message is provided to the user, indicating the reason for the timeout. An exemplary timeout message may provide: “No request received.” As discussed earlier, when a node is visited, the counters associated with that node, including the timeout counter, are reset. When a timeout message is played, the timeout counter is incremented by a certain integer value, such as 1.

The system tracks the value of the timeout counter until it reaches a threshold value. Prior to reaching the threshold value, in some embodiments, the system handles a timeout condition by replaying the prompt for the visited node again and waiting for a user response. Based on the value of the timeout counter, various timeout messages and or options may be provided to the user. For example, in some embodiments, as the value of the timeout counter increases, the messages provide more helpful information and instructions guiding the user on how to proceed. Once the timeout threshold is reached, then the system plays a last resort timeout message and returns the user to the main menu, for example.

If the system detects a request from the user, then at step 1720, the system processes the request for recognition. As described further below, in processing the request, the system assigns a confidence score to the received request. The confidence score is a value used by the system that represents the level of certainty in recognition. The system can be implemented to allow for certain thresholds to be set to monitor the level of certainty by which a request is recognized. For example, the system may reject a request if the confidence score is below a specific threshold, or may attempt to determine with more certainty (i.e., disambiguate) a request with a confidence score that falls within a specific range.

In some embodiments, if the system cannot recognize or disambiguate a request at step 1720, then the request is not recognized at step 1730 and is therefore rejected. Effectively, a request is considered not recognized when the system fails to match the request with a keyword included in the navigation grammar's vocabulary. In other words, if the request provided by the user is not part of the system's vocabulary at the specific navigation instance then it would not be recognized by the system. The system's vocabulary at each instance of navigation depends on the navigation mode as discussed in further detail herein.

Under certain circumstances, the system may reject a request, at step 1740, even if the request is recognized. For example, the system may be unavailable to service a request, if for example the system is not authorized to service that request. The system may be also unavailable to meet a user request if servicing the request requires accessing portions of the system that are either not operational or not available or authorized for access by the specific user at the instance the request is submitted. If a request is rejected pursuant to a failure in recognition or unavailability, at steps 1730 and 1740 respectively, then the system generates a rejection message, at step 1750.

In some embodiments, if a request is rejected, then the system returns the user to the prompt or greeting for that node and replays the prompt or greeting again. The system, in one or more embodiments, includes a rejection counter that tracks the number of times a user request at a certain navigation instance has been rejected. The rejection counter is incremented by a constant value each time. Depending on the value of the rejection counter, the system may provide the user with more or less detailed rejection message. Once the rejection counter reaches a certain threshold, the request is conclusively rejected and the user is returned to the main menu or other node in the navigation tree, for example.

Once the request is recognized, the system at step 1750 services the submitted request. To service the request, the system finds the navigation rules included in the navigation grammar that correspond with the submitted request. The system then performs the functions or procedures associated with one or more navigation modes or rules. In the following, a number of exemplary navigation modes are discussed.

Navigation Modes

As stated earlier, a user request is recognized if it is included in the navigation grammar at a certain navigation instance. Once a user request is recognized, several navigation modes may be utilized to navigate the navigation tree. A number of exemplary navigation modes are illustrated in FIG. 15. These various navigation modes are implemented, in one or more embodiments, to improve recognition efficiency and accuracy.

In accordance with one aspect of the invention, in some modes the navigation vocabulary is expanded at each navigation instance, while in other modes it is narrowed. Expanding the navigation vocabulary provides the system with the possibility of recognizing and servicing more user requests, in the same manner that a person with a vast vocabulary is, typically, better equipped to comprehend written or spoken language. Unfortunately, due to limitations associated with recognition software today, as the system vocabulary increases, so does the possibility that the system will not properly recognize a word or phrase. This failure in proper recognition is referred to herein as an act of “misrecognition.” Therefore, in some embodiments of the system, to maximize recognition, the navigation vocabulary is narrowed to include keywords that are most pertinent to the current node at the specific navigation instance.

In one navigation mode, the grammar's vocabulary includes basic navigation commands that allow a user to navigate from one node to the node's immediate children, siblings, and parents (i.e., nodes which are included on a common branch of a navigation tree). In another navigation mode, the navigation grammar may be expanded to include additional vocabulary and rules. This expansion may be based on the type of the node being visited and the keywords associated with the node, its children, siblings, or parents.

Various navigation modes are associated with different navigation grammar and therefore provide a user with different navigation experiences. As illustrated in FIG. 15, embodiments of the system include the following exemplary navigation modes: Step mode, RAN mode, and Stack mode. To activate a certain mode, a user provides the keyword associated for that mode. For example, to activate the RAN mode the user may say “RAN.” In certain embodiments, however, the system is implemented to switch to the navigation mode most appropriate for the particular navigation instance.

The Step mode, in some embodiments, is the default navigation mode. Other modes, however, may also be designated as the default, if desired. In the Step mode, the navigation grammar comprises a default grammar that includes a default vocabulary and corresponding rules. In accordance with one embodiment, the default grammar is available during all navigation instances. The default grammar may include commands such as “Help,” “Repeat,” “Home,” “Goto,” “Next,” “Previous,” and “Back.” The Help command activates the Help menu. The Repeat command causes the system to repeat the prompt or greeting for the current node. The Goto command followed by a certain recognizable keyword would cause the system to browse the content of the node associated with that term. The Home command takes the user back to the root of the navigation tree. Next, Previous, and Back commands cause the system to move to the next or previously visited nodes in the navigation tree.

The above list of commands is provided by way of example. In some embodiments, the default vocabulary may include none or only one of the above keywords, or keywords other than those mentioned above. Some embodiments may be implemented without a default grammar, or a default grammar that includes no vocabulary, for example. In certain embodiments, as the user navigates from one node to the other, the navigation grammar is expanded to further include vocabulary and rules associated with one or more nodes visited in the navigation route.

For example, in some embodiments, in the Step mode, the grammar at a specific navigation instance comprises vocabulary and rules associated with the currently visited node. In other embodiments, the grammar comprises vocabulary and rules associated with the nodes that are most likely to be accessed by the user at that navigation instance. In some embodiments, the most likely accessible nodes are the visiting node's neighboring nodes. As such, as navigation instances change, so does the navigation grammar.

The grammar, in one embodiment, can be extended to also include the keywords associated with the siblings of the current node. For example, referring to FIG. 9, if the currently visited node is Routing Node 2.1, then in the Step mode, the navigation vocabulary includes, for example, the default vocabulary in addition to keywords associated with Routing Node 2.1 (the current node), Routing Node 2 (the parent node), Group Node 2.1.1 (the child node), and Content Node 2.2 and Routing Node 2.3 (the sibling nodes). Due to the limited vocabulary available at each navigation instance, the possibility of misrecognition in the Step mode is very small. Because of this limitation, however, to browse a certain aspect of a web page, the user will have to navigate through the entire route in the navigation tree that leads to the corresponding node.

Limiting the navigation vocabulary and grammar at each navigation instance increases recognition accuracy and efficiency. As described in further detail below, to recognize a user request or command, the system uses a technique that compares the user provided input with the keywords included in the navigation vocabulary. It is easy to see that if the system has to compare the user's input against all the terms in the navigation vocabulary, then the scope of the search includes all the nodes in the navigation tree.

By limiting the vocabulary, the scope of the search is narrowed to a certain group of nodes. Effectively, limiting the scope of the search increases both recognition efficiency and accuracy. The recognition efficiency increases as the system processes and compares a smaller number of terms. The recognition accuracy also increases because the system has a smaller number of recognizable choices and therefore less possibilities of mismatching a user request with an unintended term in the navigation vocabulary.

When the system receives a user request (e.g., a user utterance), if the system at step 1805 is in the Step mode, then it compares the user request against the navigation vocabulary associated with the current node. If the request is recognized, then the system will move to the node requested by the user. For example, if the user request includes a keyword associated with a child of the current node, then the system recognizes the request and will go to the child node, at step 1810. Otherwise, the request is not recognized and is further processed as provided below.

In one embodiment in the Step mode, the system is highly efficient and accurate because navigation is limited to certain neighboring nodes of the current node. As such, if a user wishes to navigate the navigation tree for content that is included or associated with a node not within the immediate vicinity of the current node, then the system may have to traverse the navigation tree back to the root node. For this reason, the system is implemented such that if the system cannot find a user request then the system may switch to a different navigation mode or provide the user with a message suggesting an alternative navigation mode.

In contrast to the Step mode, in the RAN mode the default grammar is expanded to include keywords that are associated with one or more nodes that are within or outside the current navigation route. For example, in one embodiment, RAN mode grammar covers all the nodes in the navigation tree. As such, a user request is recognized if it can be matched with a term associated with any of the nodes within the navigation tree. Thus, in the RAN mode the user does not need to traverse back down to the root of the navigation tree node by node to access the content of a node that is included in another branch of the navigation tree.

Due to this broad navigation scope, a user request may be matched with more than one command or keyword. If so, then the system proceeds to resolve this conflict by either determining the context in which the request was provided, or by prompting the user to resolve this conflict. Thus, if the system at step 1815 determines the RAN mode is activated, then at that navigation instance the system expands the navigation grammar to RAN mode grammar, until RAN mode is deactivated. If the user request in the RAN mode is recognized, then at step 1820, the system goes to the requested node.

Some embodiments of the system are implemented to also provide another navigation mode called the Stack mode. The Stack mode is a navigation model that allows a user to visit any of the previously visited nodes without having to traverse back each node in the navigation tree. That is, navigation grammar in the stack mode includes commands and navigation rules encountered during the path of navigation.

In an exemplary embodiment, in Stack mode, the navigation vocabulary comprises keywords associated with the nodes previously visited, when the navigation path includes a plurality of branches of the navigation tree. Thus, in the Stack mode, the user is not limited to only moving to one of the children or the parent of the currently visited node, but it can go to any previously visited node. In the Stack mode, the system tracks the path of navigation by expanding the navigation grammar to include vocabulary associated with the visited nodes to a stack. A stack is a special type of data structure in which items are removed in the reverse order from that in which they are added, so the most recently added item is the first one removed. Other types of data structures (e.g., queues, arrays, linklists) may be utilized in alternative embodiments.

In some embodiments, the expansion is cumulative. That is, the navigation grammar is expanded to include vocabulary and rules associated with all the nodes visited in the navigation route. In other embodiments, the expansion is non-cumulative. That is, the navigation grammar is expanded to include vocabulary and rules associated with only certain nodes visited in the navigation route. As such, in some embodiments, upon visiting a node, the navigation grammar for that navigation instance is updated to remove any keywords and corresponding rules associated with one or more previously visited nodes and their children from the navigation vocabulary.

Because of its limited navigation vocabulary, the Stack mode too provides for accurate recognition but limited navigation options. In some embodiments, the Stack mode is implemented such that the navigation grammar includes more than the above-listed limited vocabulary. For example, certain embodiments may have navigation vocabulary that is a hybrid between the Step mode and RAN mode such that the navigation grammar is comprised of the default vocabulary expanded to include the keywords associated with the current node, its neighboring nodes, certain most frequently referenced nodes, and the previously visited nodes in the path of navigation.

For example, referring to FIG. 9, the system may be at a navigation instance in which Routing Node 2 is the currently visited node. In an exemplary Stack mode, the navigation vocabulary may include:

(1) Default grammar including default vocabulary and corresponding rules that allows a user to use general commands (“Help,” “Next,” “Previous,” and “Home”) to invoke help and move to the next, previous, or home nodes;

(2) Keywords and corresponding rules associated with the current node (e.g., Routing Node 2) and its children (e.g., routing nodes 2.1, 2.3, and Content Node 2.2);

(3) Keywords and corresponding rules associated with Content Node 2.3.2.1, where Content Node 2.3.2.1 is the most frequently accessed node; and

(4) Keywords and corresponding rules associated with previously visited nodes in the path of navigation (e.g., Routing Node 1, Group Node 1. 1, and Content Node 1.1. 1, where the left branch of navigation tree 1020 was traversed prior to visiting Routing Node 2).

As provided in the above example, in the Stack mode, in addition to the keywords and rules associated with the most frequently accessed nodes, the navigation grammar may include default vocabulary. For example, the command “next,” in one embodiment, causes the system to go to the first child of the current node. In another embodiment, the “next” command may be associated with a rule that is implemented differently. For example, the rule may be implemented to cause the system to go to the last child of the current node.

Now referring back to FIG. 15, in the above example, if the system at step 1825 determines that the Stack mode is activated, then at that navigation instance the system limits the navigation grammar to the above grammar, for example. A user request is then processed. If the user request in the Stack mode is recognized (i.e., the request is matched with keywords in the navigation stack), then at step 1830, the system goes to the node in the stack. If the user request is not recognized in any of the navigation modes, the system determines at step 1855 if there are any further options available to the user and provides those options to the user at step 1860.

The above implementations of the various modes, including the Stack mode, RAN mode, and the Step mode are provided by way of example. Other modes and implementations may be employed depending on the needs and requirements of the system.

Method For Resolving Recognition Ambiguity

FIG. 16 is a flow diagram of an exemplary method 1900 for resolving recognition ambiguity. Method 1900 may correspond to one aspect of operation for voice browsing system 10. As briefly discussed earlier, when a user request is provided to the system, the system uses a certain method to assign a confidence score to the provided request. The confidence score is assigned based on how close of a match the system has been able to find for the user request in the navigation vocabulary at that navigation instance.

In embodiments of the system, to compare a user request against the navigation vocabulary, the user request or the keywords included in the request are broken down into one or more phonetic elements. A phonetic element is the smallest phonetic unit in each request that can be broken down based on pronunciation rather than spelling. In some embodiments, the phonetic elements for each request are calculated based on the number of syllables in the request. For example, the word “weather” may be broken down into two phonetic elements: “wê” and “thê.”

The phonetic elements specify allowable phonetic sequences against which a received user utterance may be compared. Mathematical models for each phonetic sequence are stored in a database. When a request containing a spoken utterance is received by the system, the utterance is compared against all possible phonetic sequences in the database. A confidence score is computed based on the probability of the utterance matching a phonetic sequence. A confidence score, for example, is highest if a phonetic sequence best matches the spoken utterance. For a detailed study on this topic please refer to “F. Jelinek, Statistical Methods for Speech Recognition, MIT Press; Cambridge, Mass. 1997.”

Referring to FIG. 16, at step 1905, the confidence score calculated for the user request is compared with a rejection threshold. A rejection threshold is a number or value that indicates whether a selected phonetic sequence from the database can be considered as the correct match for the user request. If the confidence score is higher than the rejection threshold, then that is an indication that a match may have been found. However, if the confidence score is lower than the rejection threshold, that is an indication that a match is not found. If a match is not found, then the system provides the user with a rejection message and handles the rejection by, for example, giving the user another chance to submit a new request.

The recognition threshold is a number or value that indicates whether a user utterance has been exactly or closely matched with a phonetic sequence that represents a keyword included in the grammar's vocabulary. If the confidence score is less than the recognition threshold but greater than the rejection threshold, then a match may have been found for the user request. If, however, the confidence score is higher than the recognition threshold, then that is an indication that a match has been found with a high degree of certainty. Thus, if the confidence score is not between the rejection and recognition thresholds, then the system moves to step 1907 and either rejects or recognizes the user request.

Otherwise, if the confidence score is between the recognition threshold and the rejection threshold, then the system attempts to determine with a higher degree of certainty whether a correct match can be selected. That is, the system provides the user with the best match or matches found and prompts the user to confirm the correctness or accuracy of the matches. Thus, at step 1910, the system builds a prompt using the keywords included in the user request. Then, at step 1915, the system limits the system's vocabulary to “yes” or “no” or to the matches found for the request.

At step 1920, the system plays the greeting for the current node. For example, the system may play: “You are at Weather.” The greeting may also include an indication that the system has encountered a situation where the user request cannot be recognized with certainty and therefore, it will have to resolve the ambiguity by asking the user a number of questions. At step 1925, the system plays the prompt. The prompt may ask the user to repeat the request or to confirm whether a match found for the request is in fact, the one intended by the user.

For example, assume that the user at the Weather node in response to the prompt “What city?” had said “Los Alamos.” After processing the request, assuming that the system is not successful in finding a match to satisfy the recognition threshold, the system builds a prompt that includes the best match or matches found in the database and asks the user to confirm the match or matches found. For example the system may provide: “Did you say Los Angeles or Las Vegas?”

In certain embodiments, to maximize the chances of recognition, the system may limit the system's vocabulary at step 1915 to the matches found. At step 1930, the system listens with limited grammar to receive another request or confirmation from the user. The system then repeats the recognition process and if it finds a close match from among the limited vocabulary, then the user request is recognized at step 1940. Otherwise, the system rejects the user request. In other embodiments, the system may actively guide the user through the confirmation process by providing the user with the best matches found one at a time and asking the user to confirm or reject each match until a correct match is found. If none of the matches are confirmed by the user, then the system rejects the request.

Method For Generating a Navigation Tree

FIG. 17 is a flow diagram of an exemplary method 200 for generating a navigation tree 50, according to an embodiment of the invention. Method 200 may correspond to the operation of navigation tree builder component 40 of browser module 32.

Method 200 begins at step 202 where navigation tree builder component 40 receives a conventional markup language document 58 from a content provider 12. The conventional markup language document, which may support a respective web page, may comprise content 15 and formatting for the same. At step 204, markup language parser 52 parses the elements of the received markup language document 58. For example, content 15 in the markup language document 58 maybe separated from formatting tags. At step 206, markup language parser 52 generates a document tree 60 using the parsed elements of the conventional markup language document 58.

At step 208, navigation tree builder component 40 receives a style sheet document 62 from the same content provider 12. This style sheet document 62 may be associated with the received conventional markup language document 58. The style sheet document 62 provides metadata, such as declarative statements (rules) and procedural statements. At step 210, style sheet parser 54 parses the style sheet document 62 to generate a style tree 64.

Tree converter 56 receives the document tree 60 and the style tree 64 from markup language parser 52 and style sheet parser 54, respectively. At step 212, tree converter 56 generates a navigation tree 50 using the document tree 60 and the style tree 64. In one embodiment, among other things, tree converter 56 may apply style sheet rules and heuristic rules to the document tree 60, and map elements of the document tree 60 into nodes of the navigation tree 50. Afterwards, method 200 ends.

Method For Applying Style Sheet Rules To a Document Tree

FIG. 19 is a flow diagram of an exemplary method 300 for applying style sheet rules to a document tree 60, according to an embodiment of the invention. Method 300 may correspond to the operation of style sheet engine 68 in tree converter 56 of voice browsing system 10. In general, style sheet engine 68 selects various nodes of a document tree 60 and applies style sheet rules to these nodes as part of the process of converting the document tree 60 into a navigation tree 50.

Method 300 begins at step 302, where selector module 74 of style sheet engine 68 selects various nodes of a document tree 60 for clipping. As used herein, clipping may comprise saving the various selected nodes so that these nodes will remain or stay intact during the transition from document tree 60 into navigation tree 50. Nodes are clipped if they are sufficiently important. At step 304, rule applicator module 76 clips the selected nodes.

At step 306, selector module 74 selects various nodes of the document tree 60 for pruning. As used herein, pruning may comprise eliminating or removing certain nodes from the document tree 60. For example, nodes are desirably pruned if they have content (e.g., image or animation files) that is not suitable for audio presentation. At step 308, rule applicator module 76 prunes the selected nodes.

At step 310, selector module 74 of style sheet engine 68 selects certain nodes of the document tree for filtering. As used herein, filtering may comprise adding data or information to the document tree 60 during the conversion into a navigation tree 50. This can be done, for example, to add information for a prompt or label at a node. At step 312, rule applicator module 76 filters the selected nodes.

At step 314, selector module 74 selects certain nodes of document tree 60 for conversion. For example, a node in a document tree having content arranged in a table format can be converted into a routing node for the navigation tree. At step 316, rule applicator module 76 converts the selected nodes. Afterwards, method 300 ends.

Method For Applying Heuristic Rules To a Document Tree

FIG. 20 is a flow diagram of an exemplary method 400 for applying heuristic rules to a document tree 60, according to an embodiment of the invention. In one embodiment, method 400 may correspond to the operation of heuristic engine 70 in tree converter 56 of voice browsing system 10. These heuristic rules can be learned by heuristic engine 70 during the operation of voice browsing system 10. Each of the heuristic rules can be applied separately to various nodes of the document tree 60. Application of heuristic rules can be done on a node-by-node basis during the transformation of a document tree 60 into a navigation tree 50.

Method 400 begins at step 402, where heuristic engine 70 selects a node of document tree 60. At step 404, heuristic engine 70 may convert page and line breaks in the content contained at such node into white space. This is done to eliminate unnecessary formatting and yet not concatenate content (e.g., text). At step 406, heuristic engine 70 exploits image alternative tags within the content of a web page. These image alternative tags generally point to content which is provided as an alternative to images in a web page. This content can be in the form of text which is read or spoken to a user with a hearing impairment (e.g., deaf). Since this alternative content is appropriate for delivery by speech or audio, heuristic engine 70 exploits the image alternative tags.

At step 408, if the node is decorative, heuristic engine 70 deletes such node from the document tree 60. In one embodiment, nodes may be considered to be decorative if they do not provide any useful function in a navigation tree 50. For example, a content node consisting of only an image file may be considered to be decorative since the image cannot be presented to a user in the form of speech or audio.

At step 410, heuristic engine 70 merges together content and associated links at the node in order to provide a continuous flow of data to a user. Otherwise, the internal links would act as disruptive breaks during the delivery of content to users. At step 412, heuristic engine 70 builds outlines of headings and ordered lists in the document tree.

After all applicable heuristic rules have been applied to the current node, then at step 414 heuristic engine 70 determines whether there are any other nodes in the document tree 60 which should be processed. If there are additional nodes, then method 400 returns to step 402, where the next node is selected. Steps 402 through 414 are repeated until the heuristic rules are applied to all nodes of the document tree 60. When it is determined at step 414 that there are no other nodes in the document tree, method 400 ends.

Method For Mapping a Document Tree Into a Navigation Tree

FIG. 20 is a flow diagram of an exemplary method 500 for mapping a document tree 60 into a navigation tree 50, according to an embodiment of the invention. Method 500 may correspond to the operation of mapping engine 72 in tree converter 56 of navigation tree builder component 40. Method 500 may be performed on a node-by-node basis during the transformation of a document tree 60 into a navigation tree 50.

Method 500 begins at step 502, where mapping engine 72 selects a node of the document tree 60. At step 504, mapping engine 72 determines whether the selected node contains content. If the selected node contains content, then at step 506 mapping engine 72 creates a content node in the navigation tree 50. A content node of the navigation tree 50 comprises content that can be presented or played to a user, for example, in the form of speech or audio, during navigation of the navigation tree 50. Afterwards, method 500 returns to step 502, where the next node in the document tree is selected.

Otherwise, if it is determined at step 504 that the current node is not a content node, then at step 508 mapping engine 72 determines whether the selected node contains an ordered list, an unordered list, or a table row. If the currently selected node comprises an ordered list, an unordered list, or a TR, then at step 510 mapping engine 72 creates a suitable routing node for the navigation tree 50. Such routing node may comprise a plurality options which can be selected in the alternative to move to another node in the navigation tree 50. Afterwards, method 500 returns to step 502, where the next node is selected.

On the other hand, if it is determined at step 508 that the currently selected node does not contain any of an ordered list, an unordered list, or a TR, then at step 512 mapping engine 72 determines whether the currently selected node of the document tree is a node for a table. If it is determined at step 512 that the node is a table node, then at step 514 mapping engine 72 creates a suitable table node for the navigation tree 50. A table node in the navigation tree 50 is used to hold an array of information. A table node in navigation tree 50 can be a routing node. Afterwards, method 500 returns to step 502, where the next node is selected.

Alternatively, if it is determined at step 512 that the currently selected node is not a table node, then at step 516 mapping engine 72 determines whether the node of the document tree 60 contains a form. Such form may have a number of fields which can be filled out in order to collect information from a user. If it is determined that the current node of the document tree 40 contains a form, then at step 518 mapping engine 72 creates an appropriate form node for the navigation tree 50. A form node may comprise a plurality prompts which assist a user in filling out fields. Afterwards, method 500 returns to step 502, where the next node is selected.

Otherwise, if it is determined at step 516 that the current node does not contain a form, then at step 520 mapping engine 72 determines whether there are form elements at the node. Form elements can be used to collect input from a user. The information is then sent to be processed by a Web server. If there are form elements at the node, then at step 522 mapping engine 72 maps a form handling node to the form elements. Form handling nodes are provided in navigation tree 50 to collect input. This can be done either with direct input or with voice macros. Afterwards, method 500 returns to step 502 where another node is selected.

On the other hand, if it is determined at step 520 that the current node of the document tree 60 does not contain form elements, then at step 524 mapping engine 72 determines whether there are any more nodes in the document tree 60. If there are other nodes, then method 500 returns to step 502, where the next node is selected. Steps 502 through 524 are repeated until mapping engine 72 has processed all nodes of the document tree 60, for example, to map suitable nodes into navigation tree 50. Thus, when it is determined at step 524 that there are no other nodes in the document tree, method 500 ends.

Although particular embodiments of the invention have been shown and described, it will be obvious to those skilled in the art that changes and modifications may be made without departing from the invention in its broader aspects, and therefore, the appended claims are to encompass within their scope all such changes and modifications that fall within the true scope of the invention.

### Appendix A

Classes/Types of Nodes

There are two broad classes of nodes found in a navigation tree: routing nodes and content nodes. Routing nodes can be of different types, including, for example, general routing nodes, group nodes, input nodes, array nodes, and form nodes. Content nodes can also by of different types, including, for example, text and element. The allowable children type for each node can be as follows:

General Routing Node <ROUTE> Group Node, Routing Node
Group Node <GROUP>: Content Node, Group Node
Input Node <INPUT>: Content
Array Node <ARRAY>: Group Node
Form Node <FORM>: Input Node
Text Node <TEXT>
Element Node <ELEM>

Each of the routing node types can be “visited” by a tree traversal operation, which can be either step navigation or rapid access navigation. General routing nodes (<ROUTE>) permit stepping to their children. Group nodes (<GROUP>) do not permit stepping to their children.

Content nodes are the container objects for text and markup elements. Content nodes are not routing nodes and hence are not reachable other than through a routing node. A content node may have a group node for a parent. Alternatively, it can be a child of a routing node independent from a group node. A group node references data contained in the children content nodes. Element nodes correspond to various generic tags including anchor, formatting, and unknown tags. Element nodes can be implemented either by retaining an original SGML/XML tag or setting a tag attribute of the <ELEM>markup tag could contain to the SGML/XML tag.

Data Fields

Every node has a basic set of attributes. These attributes can be used to generate interactive dialogs (e.g., voice commands and speech prompts) with the user.

| // Attributes used by style sheet | |
|---|---|
| String class; | // class attribute |
| String id; | // id attribute |
| String style; | // style attributes |
| // Properties best defined in a style sheet | |
| String element; | // tag element of node |
| String node-type; | // node type (e.g., Routing) |

The “element” attribute stores the name of an SGML/XML element tag before conversion into the navigation tree. The “class” and “id” attributes are labels that can be used to reference the node. The “style” attribute specifies text to be used by the style sheet parser.

Group Node

A group node is a container for text, links, and other markup elements such as scripts or audio objects. A contiguous block of unmarked text, structured text markup, links, and text formatting markup are parsed into a set of content nodes. The group node is a parent that organizes these content nodes into a single presentational unit.

For example, the following HTML line:

Go to <A HREF = “http:://www.vocalpoint.com”> Vocal Point </A>.

could be parsed into the form shown below:

<GROUP>

Go to <A HREF = http://www.vocalpoint.com> Vocal Point </A>.

</GROUP>

This particular group node specifies that the three children nodes “Go to”, anchor link “Vocal Point”, and “.” should be presented as a single unit, not separately.

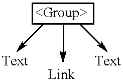

A group node does not allow its children to be visited by a tree traversal operation. Content nodes can have group nodes for parents. Consequently, content nodes are not directly reachable, but rather can be accessed from the parent group node.

A group node can sometimes be the child of another content group. In this case, the child group node is also unreachable by tree traversal operations. A special class of group node called an array node must be used to access data in nested group nodes.

Input Node

An input node is similar to a group node except for two differences. First, an input node can retrieve and store input from the user. Second, an input node can only be a child of a form node.

General Routing Node

A general routing node is the basic building block for constructing hierarchical menus. General routing nodes serve as way points in the navigation tree to help guide users to content. The children of general routing nodes are other general routing nodes or group nodes. When visited, a general routing node will supply prompt cues describing its children. An exemplary structure for a general routing node and its children is as follows:

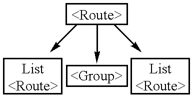

Array Node

An array node is used to build a multi-dimensional array representation of content. The HTML <TABLE> tag directly maps to an array node. To build up an array node from a document tree, information is extracted from the children element nodes.

Form Node

A form node is a parent of an input node. Form nodes collect input information from the user and execute the appropriate script to process the forms. Form nodes also control review and editing of information entered into the form. The HTML <FORM> tag directly maps to a form node.

A Brief Introduction to HML

Hierarchical markup language (HML) is designed to provide a file 20 representation of the navigation tree. HML uses the specification for XML. Content providers may create content files using HML or translation servers can generate HML files from HTML/XML and XCSS documents. HML documents provide efficient representations of navigation trees, thus reducing the computation time needed to parse HTML/XML and XCSS.

Syntax

HML elements use the “hml” namespace. A list of these elements is provided below:

| | |
|---|---|
| <hml:root> | Root of the navigation tree |
| <hml:route> | Routing node |
| <hml:group> | Group node |
| <hml:array> | Array node |
| <hml:input> | Input node |
| <hml:form> | Form node |

Abbreviated Document Type Definition

XML syntax is described using a document type definition (DTD). An abbreviated, partially complete, DTD for HML follows.

<!--================Generic Attributes================-->
<!ENTITY % coreattrs

| | | |
|---|---|---|
| “id | ID | # -- document-wide unique id |
| class | CDATA | # -- space sep. list of classes |
| style | %StyleSheet | # -- associated style info” |
| > | | |

<!ENTITY % navattrs

| | | |
|---|---|---|
| keys | CDATA | # -- space sep. list of keys |
| descriptor | CDATA | # -- short description of node |
| prompt | CDATA | # -- prompt |
| greeting | CDATA | # -- greeting |
| > | | |

<!ENTITY % attrs “coreattrs; navattrs;”>
<!--================Text Markup================-->
<!ENTITY % special “A | OBJECT | SCRIPT”>
<!ENTITY % inline “#PCDATA | %special;”>
<!--================Content Group================-->
<!ELEMENT HML:GROUP - - (%inline;)* (GROUP)*
-- content group -->
<!ATTLIST

%attrs;
>

<!--================Routing Node================-->
<!ELEMENT HML:ROUTE - - (%inline;)* (GROUP)* (ROUTE)*
-- route -->
<!ATTLIST

%attrs;
>

<!--================HTML Elements================-->
<!ELEMENT A - - -- anchor -->
<!ELEMENT OBJECT - - -- object -->
<!ELEMENT SCRIPT - - - script -->

1. A method comprising:
providing a navigation tree comprising a semantic, hierarchical structure, having one or more paths associated with content of a conventional markup language document and a grammar comprising vocabulary including one or more keywords;
receiving a request to access the content; and
responsive to the request, traversing a path in the navigation tree, if the request includes at least one keyword of the vocabulary.

2. The method of claim 1, wherein the vocabulary dynamically changes based on the path traversed in the navigation tree.

3. The method of claim 1, wherein the grammar further includes one or more rules corresponding to said one or more keywords of the vocabulary, the method further comprising:
retrieving the content according to one or more rules corresponding to said at least one keyword included in the request.

4. The method of claim 1 wherein the request is in the form of speech.

5. The method of claim 1 further comprising:
determining if the request for accessing the content includes at least one keyword of the vocabulary by searching the vocabulary to find a match for said at least one keyword in the request.

6. The method of claim 5 further comprising:
confirming that the match for the keyword is correct; and
traversing the path in the navigation tree to retrieve content related to said at least one keyword in the request.

7. The method of claim 6 further comprising:
providing a prompt including one or more keywords of the vocabulary if a match for the keyword is not found.

8. The method of claim 7 further comprising:
traversing a path in the navigation tree to retrieve content related to a keyword selected from said one or more keywords included in the prompt.

9. The method of claim 1 further comprising:
narrowing the vocabulary of the grammar if the request does not include at least one keyword of the vocabulary.

10. The method of claim 9 further comprising:
providing a prompt including one or more keywords of the narrowed vocabulary; and
traversing a path in the tree to retrieve content related to a keyword selected from said one or more keywords in the narrowed vocabulary.

11. The method of claim 10 further comprising:
expanding the vocabulary of grammar based on the path traversed in the navigation tree.

12. The method of claim 1 wherein the conventional markup language is HyperText Markup Language.

13. A method performed on a computer for browsing content available from a communication network comprising:
receiving a document containing content in a conventional markup language format and a style sheet for the document;
generating a document tree from the document;
generating a style tree from the style sheet, the style tree comprising a plurality of style sheet rules;
converting the document tree into a navigation tree using the style sheet rules, navigation tree associated with a vocabulary having one or more keywords, the navigation tree including one or more content nodes and routing nodes defining paths of the navigation tree, each content node including some portion of the content and a keyword associated with the respective portion of the content, each routing node including at least one keyword referencing other nodes in the navigation tree;
receiving a request to access the content; and
traversing a path in the navigation tree, adding keywords included in any node along the traversed path to the vocabulary in response to the request.

14. The method of claim 13 wherein the request is in the form of speech.

15. The method of claim 13 comprising:
generating a first speech recognition result indicating whether the request includes any keyword of the vocabulary;
assigning a first confidence score to the first speech recognition result; and
rejecting the request, if the first confidence score is below a rejection threshold.

16. The method of claim 11 comprising:
accepting the request if the first confidence score is greater than a recognition threshold.

17. The method of claim 16 wherein the first confidence score is between the rejection threshold and the recognition threshold, the method comprising searching the vocabulary to find one or more matches for any keyword including in the request.

18. The method of claim 15 comprising:
providing a first group of keywords included in the vocabulary from which to select if the first confidence score is below the rejection threshold;
generating a second speech recognition result in response to a selection from the first group; and
assigning a second confidence score to the second speech recognition result.

19. The method of claim 15 wherein generating comprises:
deriving a first phonetic pronunciation based on the request;
deriving a second phonetic pronunciation based on at least one keyword of the vocabulary; and
comparing the first phonetic pronunciation with the second phonetic pronunciation.

20. A method of claim 19 further comprising selecting a keyword from the vocabulary based on said comparison.

21. A method of navigating a navigation tree derived from a document having content in conventional markup language format, the navigation tree having a plurality of nodes, the navigation tree associated with a grammar comprising a vocabulary and corresponding rules, said method comprising:
visiting a first node in the navigation tree;
moving from the first node to a second node in the navigation tree in response to the user request, the second node having at least one keyword; and
expanding the grammar by adding to the vocabulary the keyword of the second node.

22. The method of claim 21, wherein the keyword of the second node identifies content included in the second node.

23. The method of claim 21 comprising providing an error message, if the user request is not recognized.

24. The method of claim 21, comprising:
comparing the request against one or more keywords included in the vocabulary; and
recognizing the request if the request is sufficiently similar to one of the keywords.

25. The method of claim 24, wherein recognizing comprises:
selecting a number of keywords from the vocabulary that are similar to the request;
for each selected keyword, assigning a value to the selected keyword based on how similar selected keyword is to the request; and
recognizing the keyword with the highest value.

26. The method of claim 25, comprising resolving an ambiguity in recognizing the request if the selected keyword with the highest value is below a recognition threshold.

27. The method of claim 26, wherein resolving comprises prompting the user to choose from one of the selected keywords.

28. The method of claim 21, comprising expanding the grammar by adding to the vocabulary any keywords associated with the nodes proximate the first node.

29. The method of claim 21, wherein the grammar is generated after the first node is visited.

30. The method of claim 21, wherein the grammar is generated before the first node is visited.

31. The method of claim 21, comprising building a greeting based on the keyword of the second node.

32. The method of claim 21, further comprising:
generating a prompt based on the portion of the content included in the first node;
playing the prompt to provide a plurality of options to select from the portion of the content included in the first node.

33. The method of claim 21, wherein the first node is a routing node which refers to other nodes in the navigation tree.

34. The method of claim 33, further comprising:
generating a prompt based on the other nodes referred to by the first node; and
playing the prompt to provide a plurality of options for moving from the first node to one of the other nodes.

35. The method of claim 21, wherein the first node is a form node associated with one or more editable fields.

36. The method of claim 35, comprising generating a prompt based on the editable fields.

37. The method of claim 36, comprising playing the prompt to provide a plurality of options for selecting from the editable fileds.

38. The method of claim 36, comprising moving through the editable fields in a prearranged order.

39. A method of navigating a navigation tree derived from a document having content in conventional markup language format, the navigation tree having a plurality of nodes, the navigation tree associated with a grammar comprising a vocabulary and corresponding rules, said method comprising:
visiting a first node in the navigation tree;
moving from the first node to a second node in the navigation tree in response to the user request, the second node having at least one keyword; and
expanding the grammar by adding to the vocabulary the keyword of the second node;
indicating that the first node is visited by providing a first message; and
indicating that no user request has been received by providing a second message.

40. The method of claim 39, comprising providing a third message with one or more options if no user request is received in response to the second message.

41. The method of claim 39, wherein the first node is a content node having at least a portion of the content, the method comprising:
providing a third message with one or more options to select from the portion of the content associated with the content node.

42. The method of claim 39, wherein the first node is a routing node which refers to the nodes of the navigation tree, the method comprising:
providing a third message with one or more options for moving to the other nodes.

43. The method of claim 42, wherein the first node is a form node having one or more editable fields, the method comprising:
providing a third message, with one or more options to select from one or more editable fields.

44. A method of navigating a routing node in a navigation tree derived from a document having content formatted in conventional markup language format, the navigation tree having a default grammar and a plurality of nodes, each node associated with one or more keywords, said method comprising:
visiting a first node in the navigation tree, the first node referencing at least a second node;
generating a navigation grammar by adding to the default grammar one or more keywords associated with the second node;
generating an output message based on said one or more keywords;
playing the output message;
waiting to receive a user request responsive to the output message;
matching the request against the keywords included in the navigation grammar;
recognizing the request, if a match is found between the request and one or more of the keywords included in the navigation grammar;
rejecting the request, if a close match is not found; and
resolving ambiguities in the request, if the request is neither recognized nor rejected.

45. The method of claim 44, wherein the navigation grammar includes rules corresponding to said one or more keywords, the method further comprising:
visiting the second node based on navigation rules corresponding with the keyword matched with the request, if the request is recognized.

46. The method of claim 45, wherein the second node references at least a third node associated with one or more keywords, said method further comprising:
expanding the navigation grammar by adding to the navigation grammar the keywords associated with the third node.

47. The method of claim 45, further comprising:
narrowing the navigation grammar by deleting from the navigation grammar the keywords associated with the second node; and
expanding the navigation grammar by adding to the navigation grammar keywords associated with the third node.

48. The method of claim 44, further comprising:
waiting to receive a user request regardless of whether or not the output message is generated or played.

49. The method of claim 45, further comprising:
initializing a timeout counter when visiting the second node.

50. The method of claim 48, further comprising:
playing a first timeout message, if a first time period has passed and no user request is received; and
incrementing the timeout counter.

51. The method of claim 50, further comprising:
playing a second timeout message, if a second time period has passed and no user request is received, wherein the second timeout message is different from the first timeout message; and
incrementing the timeout counter.

52. The method of claim 51, further comprising:
playing a last resort timeout message, if the timeout counter has reached a threshold value.

53. The method of claim 45, further comprising:
initializing a help counter when visiting the second node.

54. The method of claim 53, further comprising:
playing a first help message, in response to a first help request submitted while visiting the first node; and
incrementing the help counter.

55. The method of claim 54, further comprising:
playing a second help message, in response to a second help request submitted while visiting the first node, wherein the second help message is different from the first help message; and
incrementing the help counter.

56. The method of claim 55, further comprising:
playing a last resort help message, if the help counter has reached a threshold value.

57. The method of claim 45, further comprising:
initializing the rejection counter when visiting the second node.

58. The method of claim 57, further comprising:
playing a first rejection message, if the user request is not accepted, while visiting the first node; and
incrementing the rejection counter.

59. The method of claim 58, further comprising:
playing a second rejection message, if the user request is not accepted a second time, while visiting the first node;
incrementing the rejection counter; and
playing a last resort rejection message if the rejection counter has reached a threshold.

60. A method of navigating a form node in a navigation tree derived from a document having content formatted in conventional markup language format, the navigation tree having a default grammar and one or more nodes, said method comprising:
visiting a first node in a navigation tree, said first node referencing one or more fields, each field defined by at least a keyword;
building a navigation grammar by adding to the default grammar one or more keywords defining said one or more fields;
determining if the first node is navigable;
if the first node is navigable then performing the following actions:
generating a first output message based on the keywords defining the fields, providing the option to select from one or more of said fields;
playing the first output message;
receiving a user request responsive to the first output message;
matching the request against the keywords included in the navigation grammar;
recognizing the request, if a close match is found between the request and one or more keywords included in the navigation grammar;
rejecting the request, if a close match is not found;
resolving ambiguities in the request, if a match is not recognized or rejected;
visiting a field defined by the keyword matched with the request, if the request is recognized;
building a second output message based on the keyword matched with the request, providing an option to edit the field visited;
playing the second output message;
receiving a second user request to edit the field visited, responsive to the second output message; and
editing the field visited in response to said second user request.

61. The method of claim 60, further comprising:
if the first node is not navigable then performing the following actions:
visiting said one or more fields;
building a second output message for a visited field based on the keyword defining that field;
playing the second output message providing an option to edit the field;
receiving a second user request to edit the field, responsive to said second output message; and
editing the field in response to said second user request.

62. A method of navigating a content node in a navigation tree derived from a document having content formatted in conventional markup language format, the navigation tree associated a default grammar, said method comprising:
visiting a first node in a navigation tree, said first node referencing first content and a second content included in a conventional markup language document, each content defined by at least a keyword;
generating a navigation grammar by adding to the default grammar keywords defining the first content and the second content;
playing the first content; and
playing the second content.

63. The method of claim 62, further comprising:
building an output message based on the keywords defining the first content and the second content, providing the option to select one of the contents;
playing the output message;
receiving a user request responsive to the output message;
matching the request against the keywords included in the navigation grammar;
recognizing the request, if a match is found between the request and one or more of the keywords included in the navigation grammar and playing the content defined by the keyword matching the request;
rejecting the request, if a close match is not found; and
resolving any ambiguities in the request, if the request is not recognized or rejected.
